(19) United States
(12) Patent Application Publication
(10) Pub. No.: US 2011/0158462 A1
(43) Pub. Date: Jun. 30, 2011

(54) SPEAKER DEVICE

(75) Inventors: Minoru Horigome, Yamagata (JP); Shunichi Takahashi, Yamagata (JP); Toshihiro Hikichi, Yamagata (JP)

(73) Assignees: PIONEER CORPORATION, Tokyo (JP); TOHOKU PIONEER CORPORATION, Yamagata (JP)

(21) Appl. No.: 13/061,055

(22) PCT Filed: Jul. 9, 2009
(86) PCT No.: PCT/JP2009/062479

§ 371 Date: Feb. 25, 2011

(51) Int. Cl. H04R 1/00

(52) U.S. Cl. 381/413

(57) ABSTRACT

A speaker device including a diaphragm, a static part vibratably supporting the diaphragm, and a driving part provided at the static part and vibrating the diaphragm upon an audio signal. The driving part includes a voice coil vibrating in a direction different from the diaphragm upon the audio signal inputted, a magnetic circuit including a magnetic gap in which the voice coil is arranged, a rigid vibration direction converter part obliquely disposed with respect to the vibration direction of the voice coil and the diaphragm, and connected with the voice coil and the diaphragm, and a holding part holding the voice coil at the static part. The holding part restricts the vibration of the voice coil in one axis direction.

### FIELD OF THE INVENTION

The present invention relates to a speaker device.

### BACKGROUND OF THE INVENTION

A dynamic speaker device is known as a typical speaker device (for example, see patent literature 1). The dynamic speaker device, for example, as shown in FIG. 1, includes a frame 3J, a cone-shaped diaphragm 21J, an edge 4J through which the diaphragm 21J is supported by the frame 3J, a voice coil bobbin 610J applied to the inner periphery part of the diaphragm 21J, a damper 7J through which the voice coil bobbin 610J is supported by the frame 3J, a voice coil 611J wound around the voice coil bobbin 610J, a yoke 51J, a magnet 52J, a plate 53J, and a magnetic circuit having a magnetic gap in which the voice coil 611J is arranged. In this speaker device, when an audio signal is inputted to the voice coil 611J, the voice coil bobbin 610J vibrates by a Lorentz force developed in the voice coil 611J in the magnetic gap and the diaphragm 21J is driven by the vibration.

[Patent literature 1] Publication of unexamined patent application 118-149596 (FIG. 1)

### SUMMARY OF THE INVENTION

The typical dynamic type speaker device as described above is configured such that the voice coil 611J is disposed opposite to the sound emission side of the diaphragm 21J and the vibration directions of the voice coil 611J and the voice coil bobbin 610J are the same as the vibration direction of the diaphragm 21J, for example, as shown in FIG. 1. In the speaker device as configured above, a region for vibration of the diaphragm 21J, a region for vibration of the voice coil bobbin 610J, and a region for arranging the magnetic circuit, etc. are necessarily formed in the vibration direction (sound emission direction) of the diaphragm 21J. Accordingly, the total height of the speaker device necessarily becomes comparatively large.

Specifically, as shown in FIG. 1, the dimension of the above-mentioned speaker device in the vibration direction of the diaphragm 21J includes (a) the total height of the cone-shaped diaphragm 21J in the vibration direction and the edge 4J through which the diaphragm 21J is supported by the frame 3J, (b) the height of the voice coil bobbin from the joining part of the diaphragm 21J and the voice coil bobbin 610J to the upper end of the voice coil 611J, (c) the total height of the voice coil, (d) the height mainly of the magnet of the magnetic circuit, corresponding to the height from the lower end of the voice coil 611J to the upper end of the yoke 51J, (e) the thickness mainly of the yoke 51J of the magnetic circuit, etc. The speaker device as described above requires sufficient heights of the above-mentioned (a), (b), (c), and (d) to ensure a sufficient vibration stroke of the diaphragm 21J. Further, the speaker device requires sufficient heights of the above-mentioned (c), (d), and (e) to secure a sufficient electromagnetic force. Accordingly, particularly in a speaker device adapted to a large sound volume, the total height of the speaker device inevitably becomes large.

Since the vibration direction of the voice coil bobbin 610J is the same as that of the diaphragm 21J in the conventional speaker device as described above, the total height of the speaker device inevitably becomes large to secure a vibration stroke of the voice coil bobbin 610J, when seeking a large volume sound with large amplitude of vibration of the diaphragm 21J. Thus, it becomes difficult to make a thin device. In other words, the problem is that making a thin device and securing a loud sound are contradictory to each other.

One of the ways to solve this problem is to make the vibration direction of the voice coil different from the vibration direction of the diaphragm, and mechanically direction-convert the vibration of the voice coil and transmit the vibration of the voice coil to the diaphragm. If this is realized, increase of vibration stroke of the voice coil does not directly affect the thickness of the speaker device, and thus a thin speaker device can be realized. In order to realize a thin speaker device by this way, it is important to direction convert the vibration of the voice coil and efficiently transmit the vibration of the voice coil to the diaphragm.

When the vibration direction of the voice coil and the vibration direction of the diaphragm are different, a reaction force with the vibration of the diaphragm exerts in a direction different from the vibration direction of the voice coil. As such, the voice coil easily vibrates in a direction different from the vibration direction of the voice coil. Contact with the voice coil and the configuring member of the magnetic circuit may cause a generation of abnormal noise or damage to voice coil. The vibration of the voice coil cannot be efficiency transmitted to the diaphragm unless the vibration of the voice coil can be restricted in one axis direction.

It is an object of the present invention to overcome the problem described above. That is, an object of the present invention is to provide a thin speaker device capable of emitting loud reproduced sound, efficiently transmit the vibration of the voice coil to the diaphragm by converting the direction of vibration produced by the voice coil, and restrain generation of an abnormal noise and a damage to the voice coil by properly restricting the vibration of the voice coil.

To achieve the above-mentioned object, a speaker device according to the present invention has at least a configuration according to the following independent claim:

A speaker device comprising a diaphragm, a static part vibratably supporting the diaphragm, and a driving part provided at the static part and vibrating the diaphragm upon an audio signal, wherein the driving part includes a voice coil vibrating in a direction different from the diaphragm upon the audio signal inputted, a magnetic circuit including a magnetic gap in which the voice coil is arranged, a rigid vibration direction converter part obliquely disposed with respect to the vibration direction of the voice coil and the diaphragm, and connected with the voice coil and the diaphragm, and a holding part holding the voice coil at the static part, and the holding part restricts the vibration of the voice coil in one axis direction.

### BRIEF DESCRIPTION OF THE DRAWINGS

FIG. 1 is a view illustrating a speaker device of a conventional art.

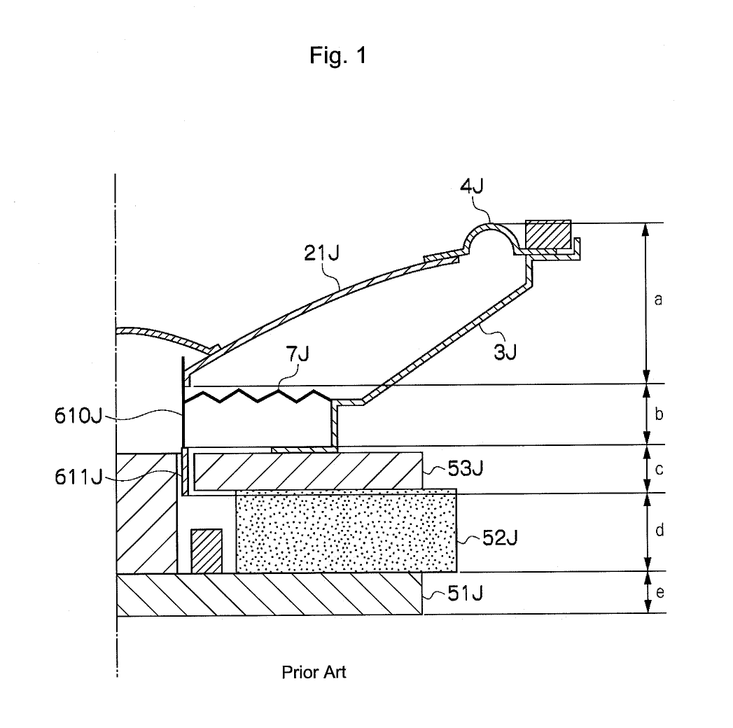

FIG. 2 is a view illustrating a basic configuration of the speaker device according to an embodiment of the present invention (FIG. 2(a) is a cross-sectional view taken along X-axis direction and FIG. 2(b) is a view illustrating an operation of the driving part).

FIGS. 3(a)-(c) are views illustrating a configuration example and an operation of a vibration direction converter part.

FIGS. 4(a)-(c) are views illustrating a configuration example and an operation of the vibration direction converter part.

FIG. 5 is a view illustrating a formation example of the vibration direction converter part (FIG. 5(a) is a side view, FIG. 5(b) is a perspective view and FIG. 5(c) is an enlarged view of part A).

FIGS. 6(a)-(c) are views illustrating a formation example of the vibration direction converter part.

FIG. 7 is a view illustrating a speaker device adopting the vibration direction converter part (FIG. 7(a) is a cross-sectional view taken along X-axis direction and FIG. 7(b) is a view illustrating an operation of the driving part).

FIG. 8 is a view illustrating a speaker device adopting the vibration direction converter part (FIG. 8(a) is a cross-sectional view taken along X-axis direction and FIG. 8(b) is a view illustrating an operation of the driving part).

FIGS. 9(a)-(b) are views illustrating a specific vibration direction converter part.

FIGS. 10(a)-(b) are views illustrating a specific vibration direction converter part.

FIGS. 11(a)-(b) are views illustrating another example of the vibration direction converter part.

FIG. 12 is a view illustrating another example of the vibration direction converter part.

FIGS. 13(a)-(c) are views illustrating another example of the vibration direction converter part.

FIGS. 14(a)-(b) are views illustrating another example of the vibration direction converter part.

FIG. 15 is a view illustrating a holding part of the speaker device according to an embodiment of the present invention.

FIGS. 16(a)-(c) are views illustrating a holding part of the speaker device according to an embodiment of the present invention.

FIGS. 17(a)-(d) are views illustrating a holding part of the speaker device according to an embodiment of the present invention.

FIGS. 18(a)-(c) are views illustrating a holding part of the speaker device according to an embodiment of the present invention.

FIGS. 19(a)-(b) are views illustrating a holding part of the speaker device according to an embodiment of the present invention.

FIG. 20 is a view illustrating a holding part of the speaker device according to an embodiment of the present invention.

FIG. 21 is a view illustrating a holding part of the speaker device according to an embodiment of the present invention.

FIG. 22 is a view illustrating a holding part of the speaker device according to an embodiment of the present invention.

FIGS. 23(a)-(d) are views illustrating a holding part of the speaker device according to an embodiment of the present invention.

FIG. 24 is a view illustrating a holding part of the speaker device according to an embodiment of the present invention.

FIGS. 25(a)-(b) are views illustrating a holding part of the speaker device according to an embodiment of the present invention.

FIGS. 26(a)-(b) are views illustrating a holding part of the speaker device according to an embodiment of the present invention.

FIGS. 27(a)-(c) are views illustrating a holding part of the speaker device according to an embodiment of the present invention.

FIG. 28 is a view illustrating the speaker device according to an embodiment of the present invention.

FIG. 29 is a view illustrating the speaker device according to an embodiment of the present invention.

FIG. 30 is a view illustrating the speaker device according to an embodiment of the present invention.

FIG. 31 is a view illustrating the speaker device according to an embodiment of the present invention.

FIGS. 32(a)-(b) are views illustrating an on-board example of the speaker device according to an embodiment of the present invention.

FIG. 33 is a view illustrating an on-board example of the speaker device according to an embodiment of the present invention.

### DETAILED DESCRIPTION OF THE INVENTION

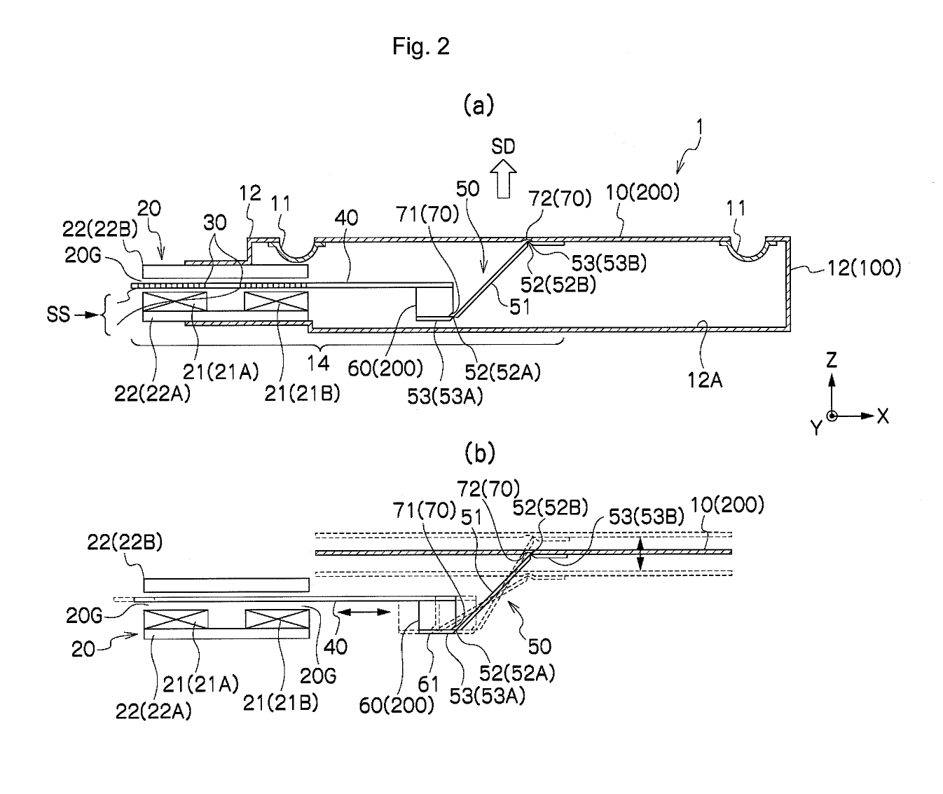

Hereinafter, an embodiment according to the present invention is described with reference to the drawings. The embodiment according to the present invention includes what is shown in the drawings, but is not limited to this alone. In the description hereinafter, the same symbol is applied to the same part as the part that has already been described, and thus a part of the same description may not be repeated.

[Speaker device: FIG. 2]

### (Basic Configuration)

FIG. 2 is a view illustrating a basic configuration of the speaker device according to an embodiment of the present invention (FIG. 2(a) is a cross-sectional view taken along X-axis direction and FIG. 2(b) is a view illustrating an operation of the driving part). The speaker device 1 includes a diaphragm 10, a static part 100 supporting the diaphragm 10 vibratably in the vibration direction and a driving part 14 arranged at the static part 100 to vibrate the diaphragm 10 in response to an audio signal. The driving part 14 includes a magnetic circuit 20 forming a magnetic gap 20G, a voice coil 30 vibrating in a direction different from the vibration direction of the diaphragm 10 upon the inputted audio signal and a vibration direction converter part 50 to convert the direction of the vibration produced by the voice coil 30 and transmit the vibration to the diaphragm 10. The voice coil 30 itself may connect with the vibration direction converter part 50, while the voice coil 30 is supported by a voice coil support part 40 as shown in the drawings. In this embodiment, the vibration direction of the voice coil 30 is X-axis direction and two directions orthogonal to X-axis direction are Y-axis direction and Z-axis direction respectively.

The diaphragm 10 may be formed substantially in a rectangular shape, a circular shape, an ellipsoidal shape or other shapes in the plan view. Further, the cross-sectional shape of the diaphragm 10 may be formed in a prescribed shape, for example, such as a tabular shape, a dome shape, a cone shape, etc. The cross-sectional shape of the diaphragm 10 is planar as shown in the drawings; however, it may be formed in a curved shape. Further, the speaker device 1 may be made thin by making the total height of the diaphragm 10 comparatively small as necessary.

The static part 100 is a collective term for those that support vibrations of the diaphragm 10, the driving part 14, etc., which includes the frame 12 and those that have also a function of the frame 12 such as an after-mentioned yoke, a mounting unit, etc. The static part 100 is, however, not necessarily completely static. The whole static part 100 may vibrate according the effect of vibration of the driving part 14 or other force. The outer periphery part of the diaphragm 10 is supported via an edge 11 by the frame 12 as the static part 100.

The driving part 14 has the magnetic circuit 20, the voice coil 30 and the vibration direction converter part 50. The voice coil 30 vibrates in one axis direction along the magnetic gap 20G of the magnetic circuit 20 and the vibration direction converter part 50 converts the direction of the vibration and transmits the vibration to the diaphragm 10. The voice coil 30 vibrates in X-axis direction and the diaphragm 10 is vibratably arranged in Z-axis direction orthogonal to X-axis direction as shown in the drawings. The vibration direction converter part 50 converts the vibration of the voice coil 30 in X-axis direction into a vibration at obliquely disposed angle of its own displacement, and thus vibrating the diaphragm 10 in Z-axis direction.

The magnetic circuit 20 has a magnet 21 (21A, 21B) and a magnetic pole member (yoke)22 (22A, 22B) such that a plurality of the magnetic gaps 20G are arranged in vibration direction of the voice coil 30, for example, in X-axis direction. In this embodiment, the magnetic pole direction of the magnet 21 (21A, 21B) is set such that magnetic field directions of a pair of the magnetic gaps 20G are opposite to each other (±Z-axis direction). The voice coil 30 made up of a wound conducting member is arranged such that currents flow in directions opposite to each other (±Y-axis direction) in the magnetic gap 20G having magnetic fields in directions opposite to each other. Thereby, a driving force (Lorentz force) may be developed in the voice coil 30 in directions (±X-axis directions) along the magnetic gap 20G. Relationship of arrangement between the magnet 21 and the magnetic pole member (yoke) 22 is not limited to the example shown in the drawings.

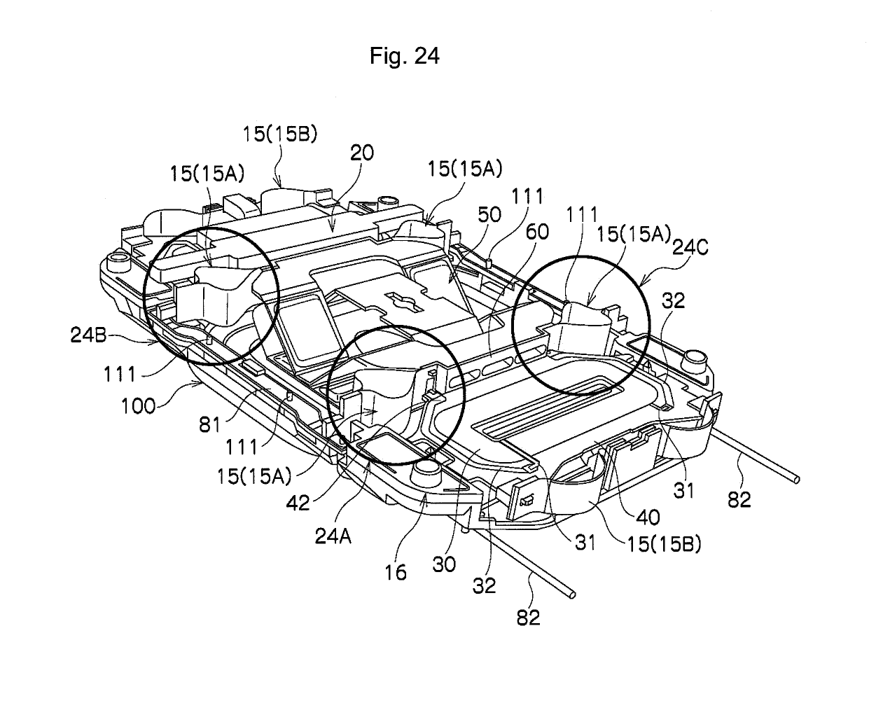

The voice coil 30 is formed by winding the conducting wire (conducting member) to which the audio signal is inputted. The voice coil 30 in itself is vibratably arranged at the static part 100 or is vibratably arranged at the static part 100 via the voice coil support part 40. The voice coil support part 40 may be formed, for example, with a tabular insulating member, and the voice coil 30 is supported on the surface of or inside the voice coil support part 40. Since the voice coil support part 40 is formed, for example, with the tabular insulating member, rigidity (bending rigidity and torsional rigidity included) may be added to the voice coil 30 as a whole. A tabular insulating member as the voice coil support part 40 has a plurality of conducting layers at the outside of a conducting wire. This conducting layer (voice coil lead wire) 32 (see FIG. 24) is electrically connected to a lead wire 31 (see FIG. 24) that is pulled out of the start point and the end point of the conducting wire. This lead wire 31 (see FIG. 24) is configured, for example, with a part of a conducting member described below. Further, the lead wire 31 is electrically connected to outside via a holding part 15 (see FIG. 24) described below, thus functioning as a junction wire to input an outside audio signal into the voice coil 30 (see FIG. 24). Further, for example, when a conducting wire freed from the voice coil is arranged in the speaker device as the junction wire, an additional space to arrange a conducting wire is required. However, since the conducting layer 32 (see FIG. 24) as the junction wire is formed on the surface of the voice coil support part 40, the space for the junction wire is no longer required, and thus the speaker device may be made thin.

As shown in the drawings, the voice coil 30 and the voice coil support part 40 are formed in a tabular shape, but they are not limited to this form and may be formed in a tubular shape. Further if the voice coil 30 or the voice coil support part 40 supporting the voice coil 30 are formed in a tubular shape, a tabular cover, which enables angle-variable connecting of the vibration direction converter part, may be connected with the end of the vibration direction converter part 50.

The voice coil 30 is held on the static part 100 with a holding part not shown in the drawings. The holding part is configured to vibratably hold the voice coil 30 or the voice coil support part 40 in vibration direction (for example, X-axis direction) with respect to the static part 100 and restrict them not to move in other directions. For example, the holding part is deformable in the vibration direction (for example, X-axis direction) of the voice coil 30. And the holding part may be formed with a curved plate member having rigidity in a direction crossing this vibration direction. Further, the length of the voice coil 30 in the direction orthogonal to the vibration direction of the voice coil thereof may be comparatively long with respect to the length of the voice coil 30 in the vibration direction of the voice coil so that a comparatively large driving force may be produced when driving a speaker.

The vibration direction converter part 50 includes a rigid link part 51 angle-variably and obliquely disposed between the voice coil 30 or the voice coil support part 40 and the diaphragm 10, and a hinge part 52, which is formed at both ends of the link part 51 and is a fulcrum for angle change of the vibration direction converter part 50. The connecting part 53 of the vibration direction converter part 50 is connected to an attaching counterpart 200 including the diaphragm 10, or the voice coil 30, or other member than the diaphragm 10 or the voice coil 30 with a coupling member including a joining member such as an adhesive or a double-faced tape, and a fastener member such as a screw, etc. The hinge part 52 is arranged in the proximity of the attaching counterpart 200. The connecting portion 53 (53A) at the end of the vibration direction converter part 50 is connected to the voice coil 30 or the voice coil support part 40 via a connecting part 60 as shown in the drawings. However, the connecting part 53(53A) may be directly connected without the connecting part 60. The connecting part 60 is formed between the end of the vibration direction converter part 50 on the voice coil side and the end of the voice coil 30 or the voice coil support part 40 on the side of vibration direction converter part, and thereby both ends are connected spaced apart in the vibration direction. Further, the connecting part 60 absorbs the thickness of the magnetic circuit, and thus allowing the speaker device to be made thin.

Further, a contact avoiding part 70 avoiding contact with the hinge part 52 is formed on the surface side of the attaching counterpart 200 in the proximity of the hinge part 52 of the vibration direction converter part 50. This contact avoiding part 70 also functions as a joining member restraining part, which restrains the joining member joining the vibration direction converter part 50 and the attaching counterpart 200. The contact avoiding part 70 is, for example, a concave portion, a notch part, a groove part, etc., which is formed in a concave shape along the hinge part 52. Accordingly, a predetermined space is formed between the hinge part 52 and the surface of the attaching counterpart 200 arranged near the hinge part 52 and thus preventing the adhesive material provided between the vibration direction converter part 50 and the attaching counterpart 200 from affecting the hinge part 52. As shown in the drawings, the notch part 71 as the contact avoiding part 70 is formed at the connecting part 60, which is the attaching counterpart 200, such that the notch part 71 is arranged in the proximity of the hinge part 52 (52A), while the concave portion 72 as the contact avoiding part 70 is formed at the diaphragm 10, such that the concave portion 72 is arranged in the proximity of the hinge part 52 (52B). As such, when the connecting part 53 of the vibration direction converter part 50 and the connecting part 60 or the end face of the diaphragm 10 are joined with the joining member such as adhesive, double-faced tape, etc., the adhesive or the end of the double-faced tape running off toward the hinge part 52 enters into the notch part 71 or the concave portion 72, and thus the adhesive or the double-faced tape is prevented from contacting and adhering to the hinge part 52.

In the above-mentioned speaker device 1, when an audio signal SS as an electric signal is inputted to the voice coil 30 of the driving part 14 as shown in FIG. 2(a), the voice coil 30 or the voice coil support part 40 vibrates along the magnetic gap 20G of the magnetic circuit 20, for example, in X-axis direction shown in FIG. 2(b). Accordingly, the vibration is direction-converted by the vibration direction converter part 50 and the vibration is transmitted to the diaphragm 10. The diaphragm 10 is vibrated, for example, in Z-axis direction shown in the figure, thereby a sound in response to the audio signal is emitted in the sound emission direction SD.

According to the speaker device 1 as described above, since the vibration direction of the voice coil 30 and the vibration direction of the diaphragm 10 can be made different from each other with the vibration direction converter part 50, the thickness on the rear side of the diaphragm 10 may be made thin compared to a case that the voice coil 30 is vibrated in the vibration direction of the diaphragm 10. As such, a thin speaker device, which may reproduce with a high sound pressure at a low frequency range, may be obtained.

Further, since the direction of the vibration produced by the voice coil 30 is converted by the vibration converter part 50 and the vibration is transmitted to the diaphragm 10, the thickness in sound emission direction of the speaker device 1 (total height of the speaker device) is not increased even if the amplitude of vibration of the diaphragm 10 is increased by increasing the amplitude of vibration of the voice coil 30. As such, a thin speaker device, which may emit a loud reproduced sound, may be realized.

Further, when the connecting part 53 of the direction converter part 50 and the attaching counterpart 200 are connected to each other by using an adhesive as an joining member, if the adhesive spreads out and runs off toward the hinge part 52 due to the join, and adheres to the hinge part 52, the hinge part 52 may be hardened and lose mobility. Also, when the double-faced tape is used as the joining member, if the end of the double-faced tape runs off toward the hinge part 52 and the double-faced tape adheres to the hinge part 52, the hinge part 52 may be hardened and lose mobility. In addition, the hinge part 52, which is adhered to and hardened by the adhesive, the end of the double-faced tape, etc. adhered thereto, may be subject to fracture by the repetition of bending, folding or rotational motion. If the hinge part 52 fractures as described above, the part to which the adhesive or the end of the double-faced tape adheres may repeatedly contact with and separate from the diaphragm 10, the voice coil 30 or the attaching counterpart 200 as other members, etc., and thus an abnormal noise (contact sound) may be generated each time. On the other hand, if the applied volume of the adhesive or the joining area by the double-faced tape is limited such that the adhesive or the double-faced tape does not run off and adhere to the hinge part 52, the coupling force between the vibration direction converter part 50 and the attaching counterpart 200 may be reduced, then detachment, etc. may occur at the end face, causing abnormal noise, or if a total detachment occurs, the speaker may eventually be fractured. Furthermore, since the hinge part 52 is arranged near the attaching counterpart 200, the hinge part 52 may contact the attaching counterpart 200. Therefore, the hinge part 52 damages, or there is a case that the vibration direction converter part 50 cannot bend, fold or rotate with respect to the attaching counterpart 200. However, in this speaker device, since the contact avoiding part 70 is formed on the surface side of the attaching counterpart 200 in proximity of the hinge part 52, it is possible to prevent the attaching counterpart 200 from contacting the hinge part 52 and restrain the generation of abnormal noise, etc. due to the contact. Further, even if the joining member such as the adhesive, double-faced tape, etc., which is used for coupling the connecting part 53 of the vibration direction converter part 50 and the attaching counterpart 200, runs off, the joining member enters into the contact avoiding part 70 that also functions as a joining member restraining part, and thus it is possible to restrain adherence of the joining member to the hinge part 52 causing hindrance to mobility thereof. As such, the function of the hinge part 52 may be maintained while the coupling force between the vibration direction converter part 50 and the attaching counterpart 200 is maintained large. Since the vibration direction converter part 50 securely bends, folds or rotates with respect to the attaching counterpart 200, contact of the hinge part 52 to the attaching counterpart 200, generation of the abnormal noise, etc. due to fracture may be restrained.

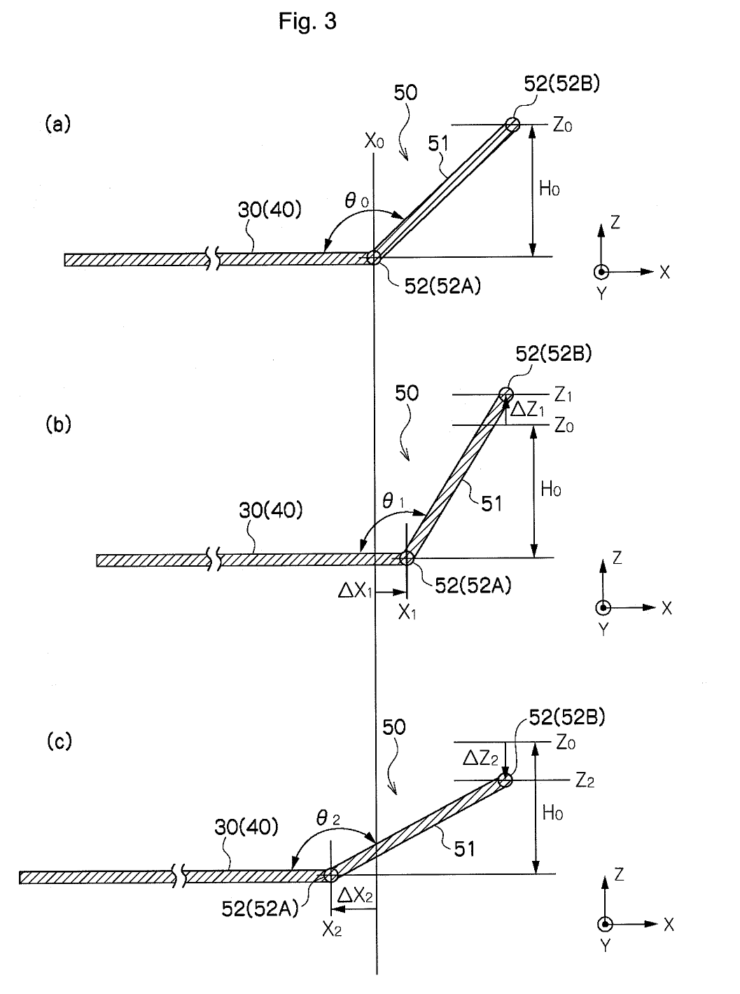

### (Vibration Direction Converter Part: FIG. 3-FIG. 14)

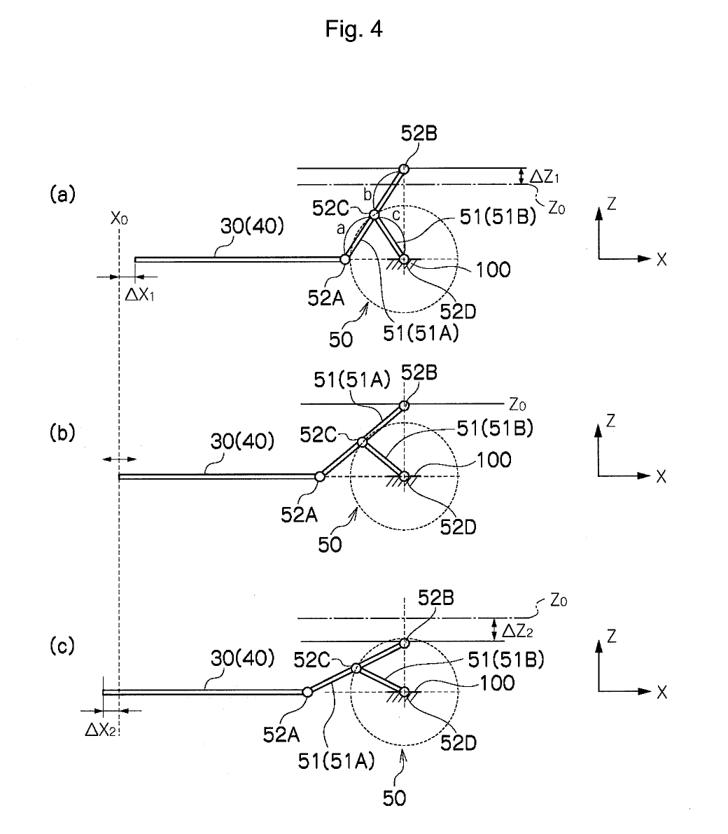

FIGS. 3 and 4 are views illustrating a configuration example and an operation of the vibration direction converter part 50. The rigid vibration direction converter part 50, direction-converting the vibration of the voice coil 30 and transmitting it to the diaphragm 10, has hinges 52 formed on the sides of the diaphragm 10 and the voice coil 30 respectively, and has the link part 51 obliquely disposed with respect to the vibration direction of the voice coil 30. The hinge part 52 is a part that rotatably joins two rigid members or a part that bends or bendably joins integrated two rigid parts, while the link part 51 is a rigid part having the hinge parts 52 formed at the ends. The rigidity means that the members and the parts are not so deformable that the vibration of the voice coil 30 can be transmitted to the diaphragm 10. It does not mean that they are totally undeformable. The link part 51 can be formed in a plate shape or in a rod shape.

In the embodiment shown in FIG. 3, one link part 51 has the hinge parts 52 (52A, 52B) formed at both ends such that the one hinge part 52A is formed at the end of the voice coil 30 or the voice coil support part 40, while another hinge part 52B is formed on the side of the diaphragm 10. Another hinge part 52B may be connected to the diaphragm 10 or connected to the diaphragm 10 via other member. A conventional member may be used as other member. For example, a metal material, etc. improving join strength between the hinge part 52 and the diaphragm 10, may be selected (diaphragm 10 is not shown in FIG. 3).

FIG. 3(a) shows that the link part 51 is in the middle position of the vibration. The link part 51 is obliquely disposed between the voice coil 30 (or voice coil support part 40) and the diaphragm 10 at an angle θ₀. Meanwhile, the hinge part 52B on the side of the diaphragm 10 is arranged at the position Z₀ apart from the voice coil 30 by distance H₀ in the vibration direction of the diaphragm 10. The vibration direction of the voice coil 30 (or voice coil support part 40) is restricted such that it may vibrate in one axis direction (for example, X-axis direction), while the vibration direction of the diaphragm 10 is restricted such that it may vibrate in a direction (for example, Z-axis direction) different from the vibration direction of the voice coil 30.

As shown in FIG. 3(b), when the hinge part 52A formed at the end of the voice coil 30 moves from position X₀ to position X₁ by ΔX₁, in the vibration direction (X-axis direction), the inclination angle of the link part 51 is converted to be θ₁ (θ₀>θ₁) and the position of the hinge part 52B on the side of the diaphragm 10 moves to position Z₁ by ΔZ₁ in the vibration direction of the diaphragm 10 (Z-axis direction). More specifically, the diaphragm 10 is pushed up by ΔZ₁ in the vibration direction.

As shown in FIG. 3(c), when the hinge part 52A formed at the end of the voice coil 30 moves from the original position X₀ to the position X₂ by ΔX₂ in the vibration direction (−X-axis direction), the inclination angle of the link part 51 is converted to be θ₂ (θ₀<θ₂) and the position of the hinge part 52B on the side of diaphragm 10 moves to position Z₂ by ΔZ₂ in the vibration direction of the diaphragm 10 (−Z-axis direction). More specifically, the diaphragm 10 is pushed down by ΔZ₂ in the vibration direction.

As such, the vibration direction converter part 50, including the link part 51 and the hinge part 52 (52A, 52B), converts vibration of the voice coil 30 to the change in the angle of the link part 51 obliquely disposed and transmits it to the diaphragm 10, and thus vibrating the diaphragm 10 in a direction different from the vibration direction of the voice coil 30.

FIG. 4 is a view illustrating another configuration example and the operation of the vibration direction converter part 50. Specifically, FIG. 4(b) shows a state of the vibration direction converter part 50 when the diaphragm 10 is positioned in a reference position, FIG. 4(a) shows a state of the vibration direction converter part 50 when the diaphragm 10 is displaced to the sound emission side from the reference position and FIG. 4(c) shows a state of the vibration direction converter part 50 when the diaphragm 10 is displaced in the direction opposite to the sound emission side from the reference position (diaphragm 10 is not shown).

The vibration direction converter part 50 has a function that the link part 51 can angle-convert by receiving reaction force from a static part 100 such as the frame 12 positioned on the opposite side of the diaphragm. Specifically, the vibration direction converter part 50 includes a first link part 51A having one end on the side of the voice coil 30 as a hinge part 52A while another end on the side of the diaphragm 10 as a hinge part 52B and a second link part 51B having one end as a hinge part 52C to the middle part of the first link part 51A while another end as a hinge part 52D to the static part 100, and the first link part 51A and the second link part 51B are obliquely disposed in different directions with respect to the vibration direction of the voice coil 30. More specifically, the vibration direction converter part 50 includes a first link part 51A having one end on the side of the voice coil 30 as a first hinge part 52A while another end on the side of the diaphragm 10 as a second hinge part 52B and a second link part 51B having one end as a third hinge part 52C to the middle part of the first link part 51A while another end as a fourth hinge part 52D to the static part 100, and the first hinge part 52A, the second hinge part 52B and the fourth hinge part 52D are located on the circumference of a circle with a diameter of substantially the same length as the first link part 51A, having the third hinge part 52C as the center.

In the vibration direction converter part 50, the hinge part 52 D, supported by the static part 100 (or frame 12), is only the hinge part that does not change position, and thus providing reaction force from the static part 100 for the link part 51. Accordingly, when the voice coil 30 (or the voice coil support part 40) moves from the reference position X₀ by ΔX₁ in the X-axis direction, angles of the first link part 51A and the second link part 51B that are obliquely disposed in different directions are increased by substantially the same angle as shown in FIG. 4(a), and thus the hinge part 52B, receiving reaction force from the static part 100 at the hinge part 52D, securely pushes up the diaphragm 10 from the reference position Z₀ by ΔZ₁ in the Z-axis direction. Further, when the voice coil 30 moves from the reference position X₀ by ΔX₂ in the direction opposite to the X-axis direction, angles of the first link part 51A and the second link part 51B are decreased by substantially the same angle as shown in FIG. 4(c), and thus the hinge part 52B, receiving reaction force from the static part 100 at the hinge part 52D, securely pushes down the diaphragm 10 from the reference position Z₀ by ΔZ₂ in the direction opposite to the Z-axis direction.

Length a of a link part from the hinge part 52A to the hinge part 52C, a length b of the link part from the hinge part 52C to the hinge part 52B and the length c of a link part from the hinge part 52C to the hinge part 52D are configured to be substantially the same as each other, and thereby the hinge part 52A and the hinge part 52D are preferably arranged substantially in parallel with the moving direction of the voice coil 30. This link body is well known as a “Scott Russell linkage” where the hinge parts 52A, 52B and 52D are located on the circumference of a circle with the length of the first link part 51A (a+b=2a) as the diameter and the hinge part 52C as the center of the circle. In particular, the angle defined by the line passing through the hinge part 52A and the hinge part 52D and the line passing through the hinge part 52B and the hinge part 52D becomes a right angle. As such, when the voice coil 30 is moved in the X-axis direction, the hinge part 52B between the first link part 51A and the diaphragm 10 moves in the Z-axis direction that is perpendicular to the X-axis, and thus it is possible to convert the vibration direction of the voice coil 30 to its orthogonal direction and transmit the vibration to the diaphragm 10.

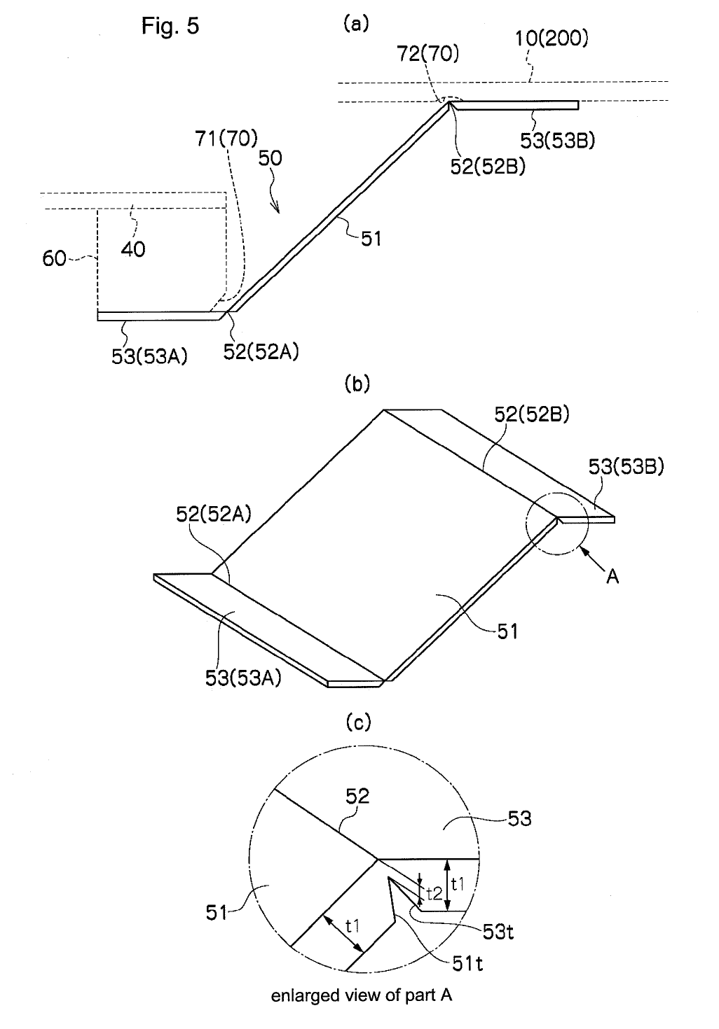

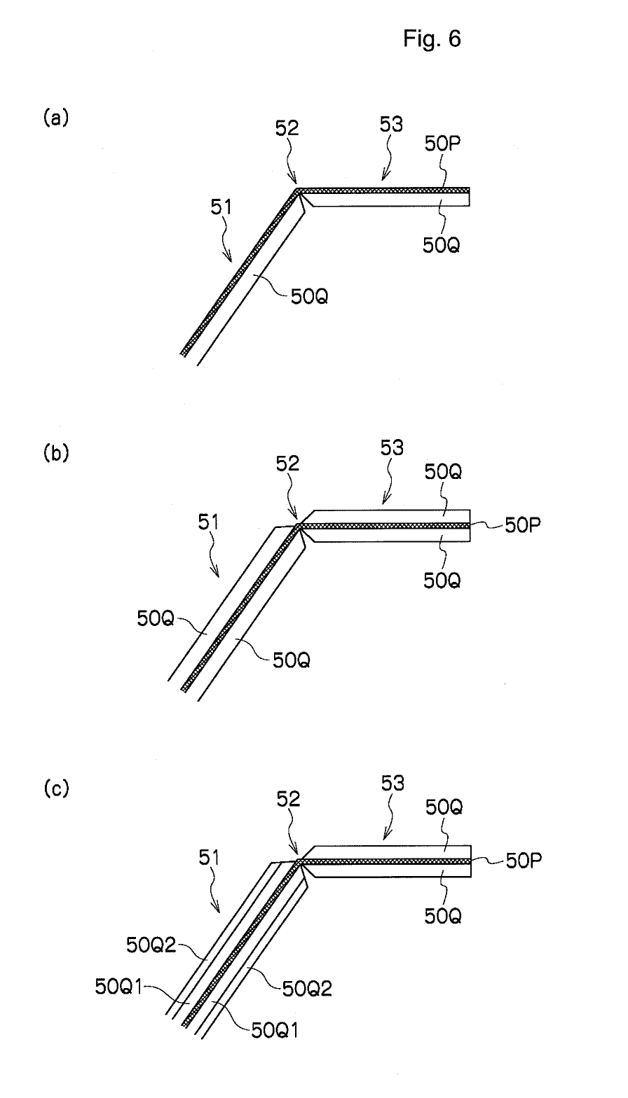

FIGS. 5 and 6 are views illustrating a formation example of the vibration direction converter part (FIG. 5(a) is a side view, FIG. 5(b) is a perspective view and FIG. 5(c) is an enlarged view of part A). The vibration direction converter part 50 includes the link part 51 and the hinge parts (52A, 52B) formed at both ends of the link part 51 as described above. As shown in the drawings, connecting parts 53 (first connecting part 53A and second connecting part 53B) are formed at both ends of the link part 51 via hinge parts 52. The first connecting part 53A, connected to the voice coil 30 or the voice coil support part 40 directly or via other member, integrally vibrates with the voice coil 30, while the second connecting part 53B, connected to the diaphragm 10 directly or via other member, integrally vibrates with the diaphragm 10.

In the vibration direction converter part 50, the link part 51, the hinge parts 52A and 52B, the first and second connecting parts 53A and 53B are integrally formed, and the hinge parts 52A and 52B are formed with a bendable continuous member continuing between the parts of both sides over the hinge parts 52A and 52B. This continuous member may be a member configuring the link part 51 and the first and the second connecting part 53A and 53B as a whole, or may be a member configuring the link part 51 and a part of the first and second connecting parts 53A and 53B. Provided with this second connecting part 53B, the link part 51 may support the diaphragm 10 over a wide range, and thereby it is possible to vibrate the diaphragm 10 in the same phase. The term “fold” includes “bend” in its conceptual scope.

If the vibration direction converter part 50 is formed with a plate shape member, the hinge part 52 is linearly formed extended in a width direction as shown in FIG. 5 (b). Further, the link part 51 is required to be rigid and not to be deformable. Since the hinge part 52 is required to be bendable, the integral member is configured to have a different property by forming the thickness t2 of the hinge part 52 smaller than the thickness t1 of the link part 51 or the connecting part 53.

Further, the change in thickness of the hinge part 52 and the link part 51 is formed on a slant face, and the slant faces 51t and 53t, facing the ends of the parts of both sides over the hinge part 52, are formed. As such, when the link part 51 is angle-varied, interference to the angle variation by thickness of the link part 51 may be restrained.

Further, a concave portion or notch part 71, which acts as a contact avoiding part 70, is formed at the end of the connecting part 60 that is an attaching counterpart 200 arranged near the hinge part 52A, such that a space is formed between the hinge part 52A and the connecting part 60 as shown in FIG. 5(a). In an example shown in FIG. 5(a), the notch part is formed in a slantwise cross-sectional shape. Furthermore, a concave portion or notch part 72, which acts as a contact avoiding part 70, is formed at the diaphragm 10 that is an attaching counterpart 200 arranged near the hinge part 52B, such that a space is formed between the hinge part 52B and the diaphragm 10. In an example shown in FIG. 5(a), the concave portion is formed in a curved cross-sectional shape. As such, contact between the hinge parts 52A, 52B and the attaching counterpart 200 may be restrained. Further, when joining the first connecting part 53A of the link part 51 with the end face of the connecting part 60, and joining the second connecting part 53B with the diaphragm 10 respectively with adhesive as a joining member, even if the adhesive runs off toward the hinge parts 52A, 52B, it will run into the concave portion or the notch part 71, 72, and therefore it will not adhere to the hinge parts 52A, 52B. Since the adhesive only adheres to a non-hinge part (unbendable or unfoldable rigid part) even if the adhesive adheres, interference to bending or folding of the hinge parts 52A, 52B may be restrained.

In an example shown in FIG. 6, a link part or a connecting part is configured by integrating a bendable continuous member and a rigid member, and a hinge part is a part that is configured by the continuous member. In the example shown in FIG. 6(a), the link part 51 or the connecting part 53 is configured by joining a rigid member 50Q to the surface of a continuous member 50P that is a bendable sheet-shaped member. According to this configuration, the continuous member 50P continuously extends between the parts of both sides over the hinge part 52, and the hinge part 52 is bendably formed substantially only by the continuous member 50P. Meanwhile, the link part 51 or the connecting part 53, which is formed by joining the rigid member 50Q to the continuous member 50P, may be formed as a rigid part.

In an example shown in FIG. 6(b), the rigid members 50Q are applied to sandwich the continuous member 50P to form the link part 51 or the connecting part 53. Also, the part, not applied with the rigid member 50Q, becomes the hinge part 52. In an example shown in FIG. 6(c), the rigid member forming the link part 51 is formed in multiple layers laminated by the rigid members 50Q1 and 50Q2. Further, in FIG. 6(c), the rigid member 50Q1 and the rigid member 50Q2 may be formed in a multiple-layer structure. As such, the bendable hinge part 52 and the rigid link part 51 and connecting part 53 may be integrally formed by partially joining the rigid member 50Q to the bendable continuous member 50P.

The continuous member 50P is preferably configured to have strength and durability durable against repeated bending of the hinge part 52 when the speaker device is driven, and have flexibility making little noise when bending is repeated. According to one embodiment, the continuous member 50P may be formed with a woven or an unwoven material made of high-strength fiber. As an example of the woven material, plain weave with uniform material, plain weave having different warp and weft material threads, plain weave with alternately changed thread material, plain weave with twisted union yarn and plain weave with paralleled yarn. Other than plain weaves, there may be applied triaxial and quadraxial woven fabrics, triaxial and quadraxial continuous non-woven fabric of glued layer, knitting, fabric with paralleled yarn in one direction, etc.

When the high-strength fiber is applied partially or as a whole, sufficient strength against vibration of the voice coil 30 or the voice coil support part 40 may be achieved by arranging the high-strength fiber in the vibration direction of the voice coil support part 40. When applying both the warp and the weft thread as the high-strength fiber, durability may be improved with a uniform tensile force given to the warp and the weft thread by inclining both fiber directions by 45° with respect to the vibration direction of the voice coil support part 40. As the high-strength fiber, aramid fiber, carbon fiber, glass fiber, etc. may be used. Further, a damping material may be applied to adjust characteristic such as bending stress and rigidity of the continuous member.

As the rigid member 50Q, thermoplastic resin, thermosetting resin, metal, paper, etc., which are light weight, easy to mold and having rigidity after hardening, may preferably be used. The vibration direction converter part 50 may be configured by joining the rigid member 50Q, which is molded in a plate shape, to the surface of the continuous member 50P other than the part of the hinge part 52 by using adhesive as a joining material. Further, if thermosetting resin is used as the rigid member 50Q, the vibration direction converter part 50 may be configured by impregnating partially the link part 51 or the connecting part 53 of the fibrous continuous member 50P with resin and then hardening it. Further, if resin or metal is used as the rigid member 50Q, the continuous member 50P and the rigid member 50Q may be integrated at the link part 51 and the connecting part 53 by using insert molding.

The above-mentioned technology concerning the integral forming is described in US20050127233 (Publication No. US2005/253298) filed in the US on May 12, 2005 and US20050128232 (Publication No. US2005/253299) filed in the US on May 13, 2005, which is incorporated here in the present application.

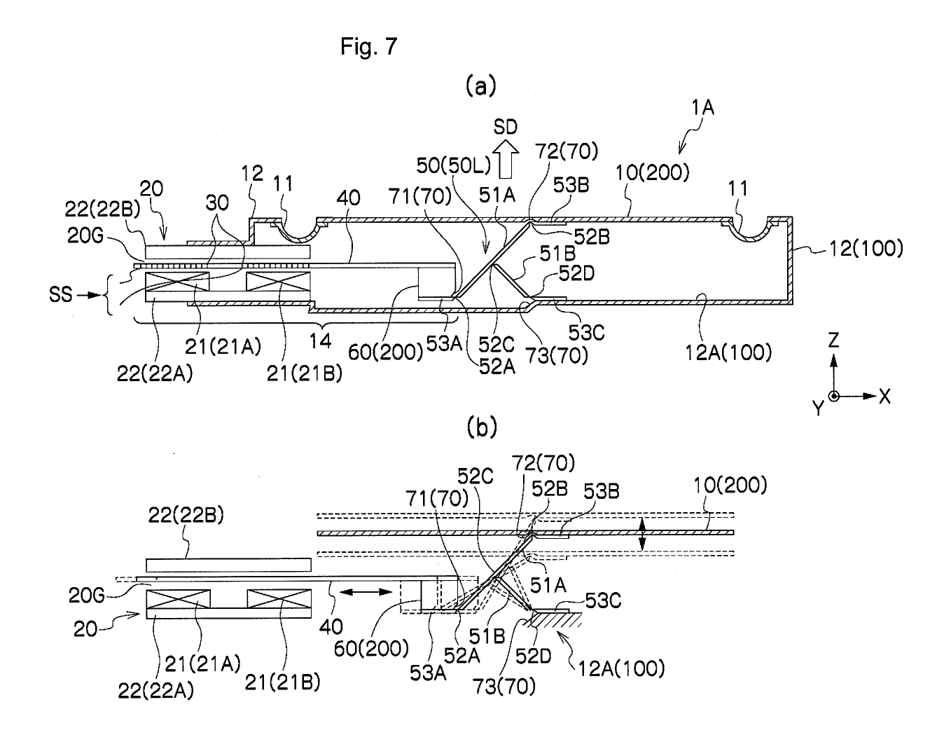

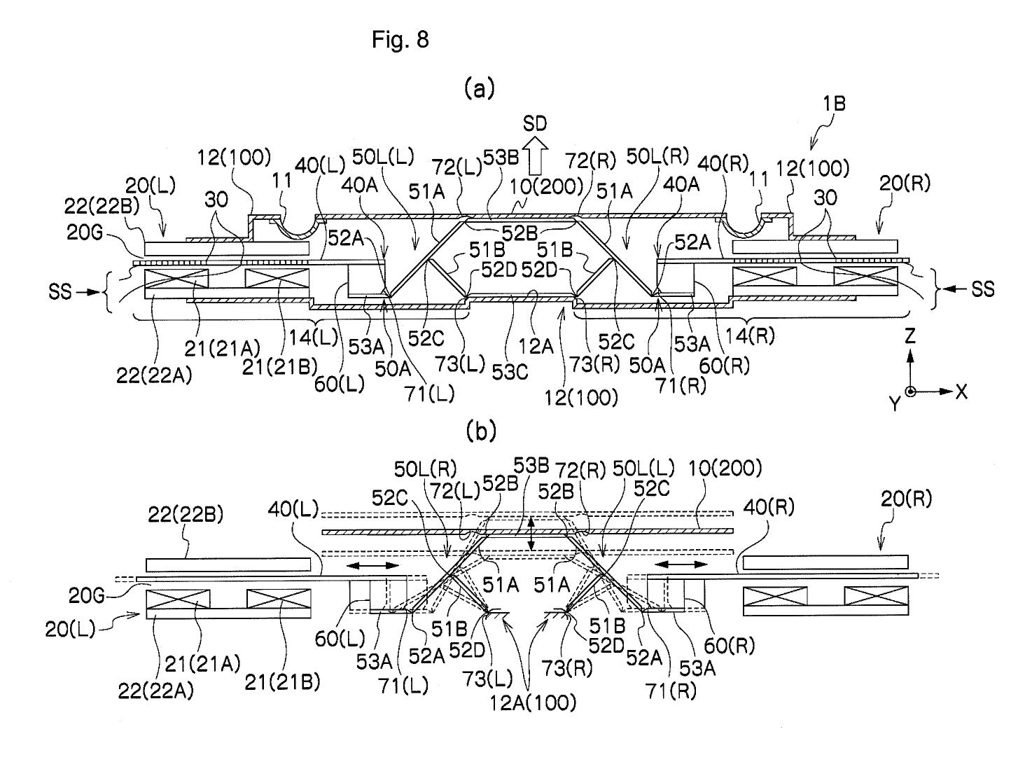

FIGS. 7 and 8 are views illustrating a speaker device adopting the above-mentioned vibration direction converter part (FIGS. 7(a) and 8(a) are cross-sectional views taken in X-axis direction and FIGS. 7(b) and 8(b) are views illustrating an operation of the driving part). The same symbols are applied to the same parts and a part of duplicate descriptions is eliminated. In a speaker device 1A, 1B shown in FIGS. 7 and 8, a link body 50L is configured to include the first connecting part 53A that is connected to the voice coil support part 40 and vibrates integrally with the voice coil support part 40 and the second connecting part 53B that is connected to the diaphragm 10 and vibrates integrally with the diaphragm 10 as well as a plurality of link parts.

In the speaker device 1A shown in FIG. 7, the vibration direction converter part 50 is formed with the link body 50L including the rigid first link part 51A and second link part 51B. The first connecting part 53A is located at one end of the first link part 51A via the hinge part 52A while the second connecting part 53B is located at another end of the first link part 51A via the hinge part 52B. The middle part of the first link part 51A is located at one end of the second link part 51B via the hinge part 52C while the connecting part 53C, which is static with respect to vibration of the voice coil support part 40, is located at another end of the second link part 51B via the hinge part 52D.

According to the drawings, the first connecting part 53A is connected to the end of the voice coil support part 40 directly or via the connecting part 60, the second coupling part 53B is directly connected to the diaphragm 10 and the static connecting part 3C is coupled to the bottom portion 12A of the frame 12 that is the static part 100. A concave portion or a notch part 73, which acts as a contact avoiding part 70, is formed at the bottom portion 12A of the frame 12 that is an attaching counterpart 200 arranged near the hinge part 52D, such that a space is formed between the hinge part 52D and the bottom portion 12A of the frame 12. In an example shown in the drawings, the notch part is formed. The first link part 51A and the second link part 51B are obliquely disposed in different directions with respect to the vibration direction (X-axis direction) of the voice coil support part 40 and the static part 100 is provided on the opposite side of the diaphragm 10 with respect to the vibration direction converter part 50. In the example shown in the drawings, although the static part 100 is formed with the bottom portion 12A of the frame 12, a yoke 22A of a magnetic circuit 20 may be the static part 100 instead of the bottom portion 12A of the frame 12 by extending the yoke 22A of the magnetic circuit 20 to the position under the vibration direction converter part 50.

As shown in FIG. 7(b), the hinge part 52A on the side of the voice coil support part 40 moves in the X-axis direction in accordance with the movement of the voice coil support part 40 while the hinge part 52D connected to the static part 100 is fixed. The movement of the hinge part 52A is converted to the change in the angles of the first link part 51A and the second link part 51B, and thus the hinge part 52B on the side of the diaphragm 10 is moved in the vibration direction of the diaphragm 10 (for example, Z-axis direction).

The speaker device 1B shown in FIG. 8 is configured with the driving parts 14 shown in FIG. 7 symmetrically disposed opposite to each other, which includes the driving parts 14(R) and 14(L), respectively. Each of the driving parts 14(R) and 14(L) includes a link body 50L(R) or 50L(L), a voice coil support part 40(R) or 40(L), a magnetic circuit 20(R) or 20(L) and a connecting part 60(R) or 60(L).

The link bodies 50L(R) and 50L(L) configure the vibration direction converter part 50 such that a pair of the first link parts 51A, a pair of the second link parts 51B, a pair of the first connecting parts 53A, the second connecting part 53B and the static connecting part 53C, which are disposed opposite to each other, are integrally formed. A pair of the first connecting parts 53A are connected to the voice coil support part 40 respectively, the second connecting part 53B is connected to the diaphragm 10, and the static connecting part 53C is connected to the bottom portion 12A of the frame 12.

As shown in FIG. 8(b), the diaphragm 10 may be driven by two combined driving forces of the driving parts 14(R) and 14(L) by setting the vibration directions of the voice coil support part 40(R) and 40(L) synchronously opposite to each other. Further, since a plurality of hinge parts 52B are provided on the side of the diaphragm 10, the number of support points on the diaphragm 10 is increased, thereby the phase of vibration of the diaphragm 10 may become uniform.

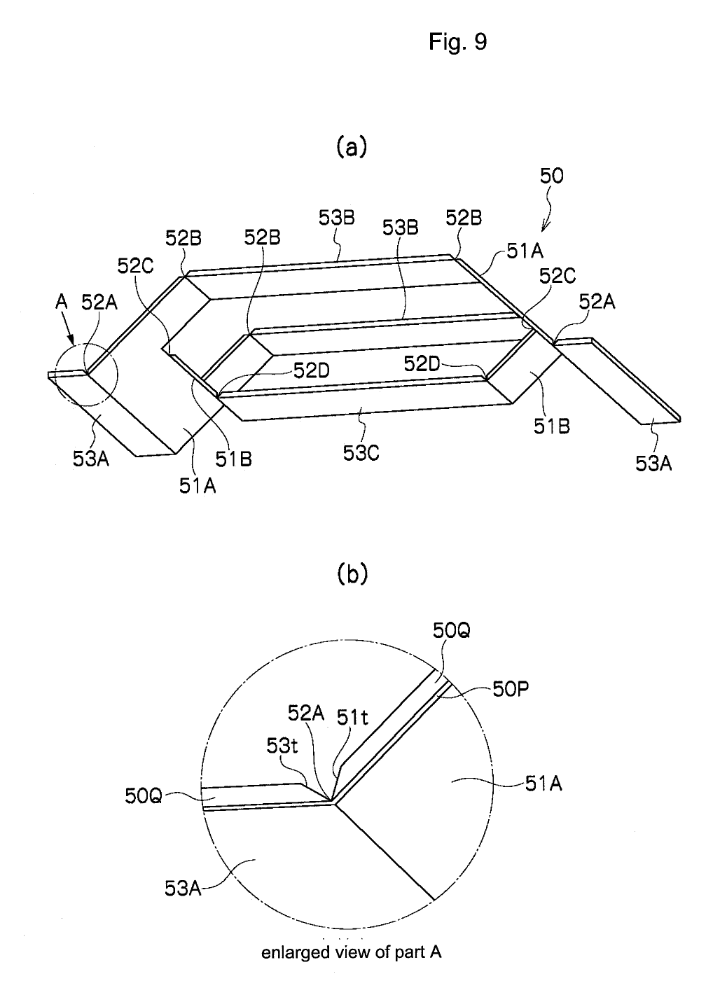

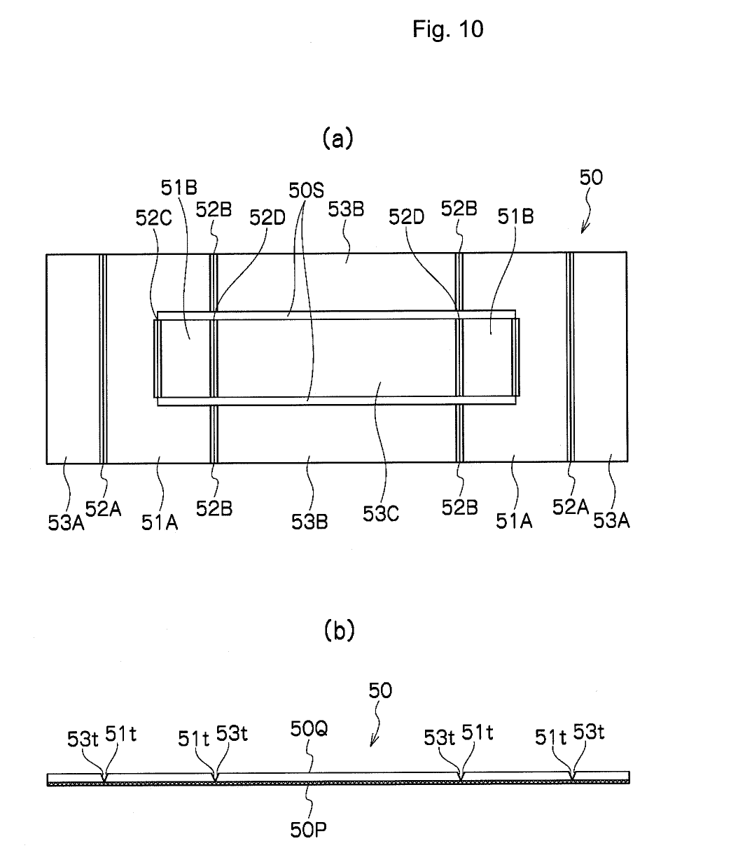

FIGS. 9 and 10 are views illustrating more specific vibration direction converter part (FIG. 9(a) is a perspective view, FIG. 9(b) is an enlarged view of part A in FIG. 9(a), FIG. 10(a) is a plan view illustrating a flattened whole part by unfolding the vibration direction converter part and FIG. 10(b) is a side view illustrating a flattened whole part by unfolding the vibration direction converter part. In this example, the vibration direction converter part 50 is formed with a single integrated component. As described above, the vibration direction converter part 50 is formed with a pair of the first link parts 51A, hinge parts 52A and 52B formed at both ends of the first link parts 51A, a pair of the second link parts 51B and hinge parts 52C and 52D formed at both ends of the second link parts 51B. Further, the first connecting parts 53A are formed at one ends of a pair of the first link parts 51A via the hinge parts 52A, the second connecting part 53B is formed between hinge parts 52B formed at other ends of a pair of the first link parts 51A and the static connecting part 53C is formed between the hinge parts 52D formed at other ends of the second link parts 51B. The first link parts 51A, 51A and the second connecting part 53B are bent in a convex shape and the second link parts 51B, 51B and the static connecting part 53C are bent in a concave shape.

As shown in FIG. 9(b), the hinge part 52A is bendably formed with the above continuous member 50P. The above rigid member 50Q is attached to the first link part 51A and also to the first connecting part 53A. Also, the first connecting part 53A is joined by the above rigid member 50Q. As such, all of the above-mentioned hinge parts are formed in the similar configuration. Further, slant faces 51t and 53t are formed opposite to each other in each hinge part.

As shown in FIG. 10(a), the vibration direction converter part 50, including the link parts 51A, 51B, each hinge part and the connecting part 53A, 53B, 53C, is formed with an integral sheet-shaped member. The hinge parts 52A are formed linearly crossing the integral sheet-shaped member, while the hinge parts 52B, 52C, 52D are formed partially crossing the integral sheet-shaped member. A pair of notch parts 50S are formed in a longitudinal direction of the integral sheet-shaped member such that the second link parts 51B, 51B and the static coupling part 53C are cut out and formed.

As shown in FIG. 10(b), the vibration direction converter part 50 is formed, for example, by applying resin material forming the rigid member 50Q to the whole surface of the continuous member 50P that is a sheet-shaped member, such that the resin material is laminated on the continuous member 50P, and cutting in a V-shape to form each hinge part and the slant faces 51t and 53t at both sides thereof. After that, the above-mentioned notch part 50S is formed and the resin material is hardened. A liquid unhardened resin material or resin film may be used as the resin material used in this embodiment.

Further, each hinge part and the slant faces 51t and 53t at both sides thereof may be formed at the same time as forming the rigid member 50Q with the resin material. It is preferable that a cross-sectional V-shape groove or a concave portion is formed preliminarily in a die, which is used to mold the rigid member 50Q.

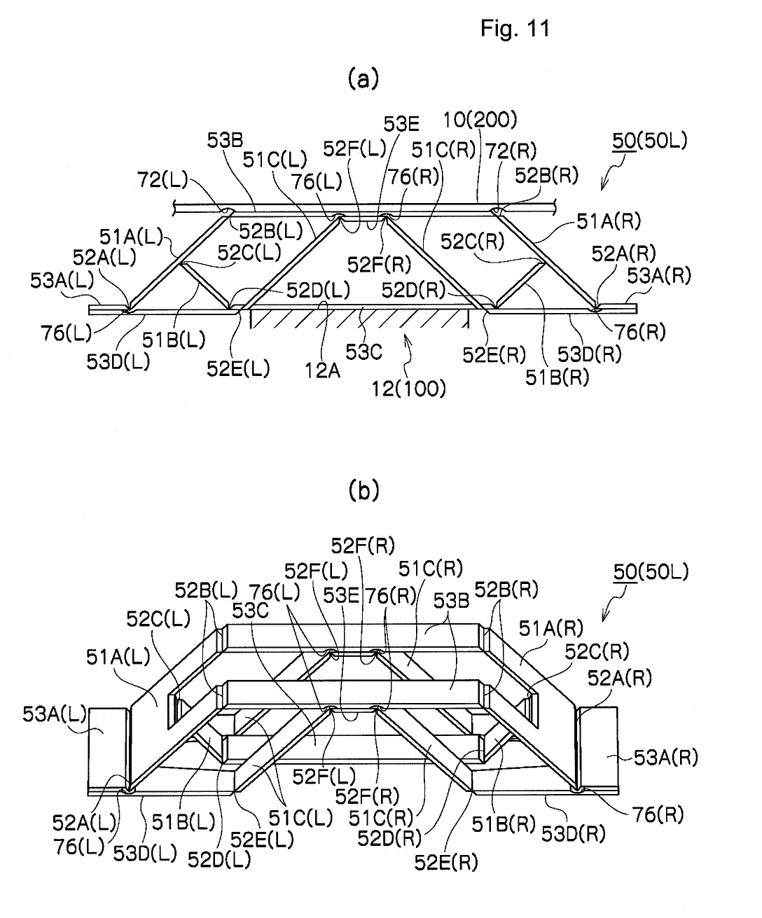

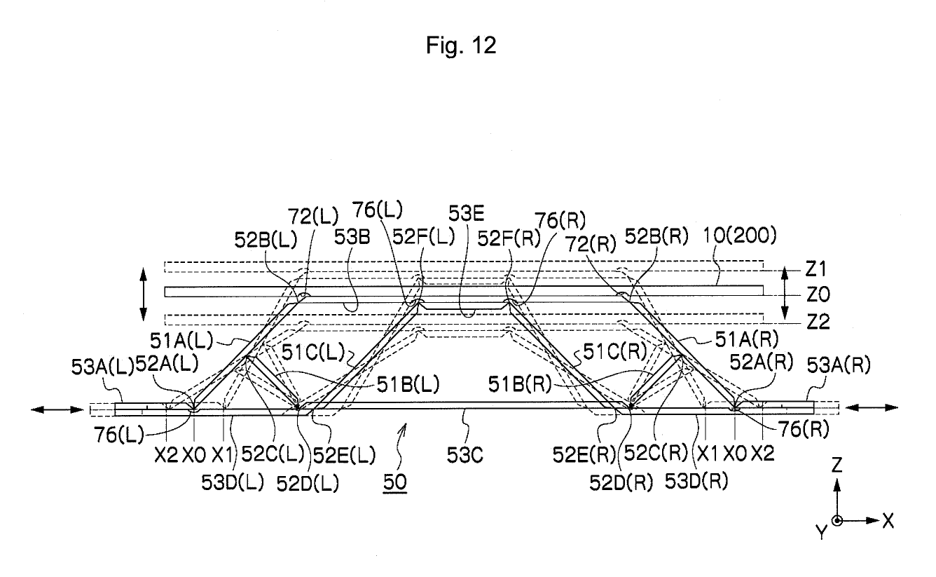

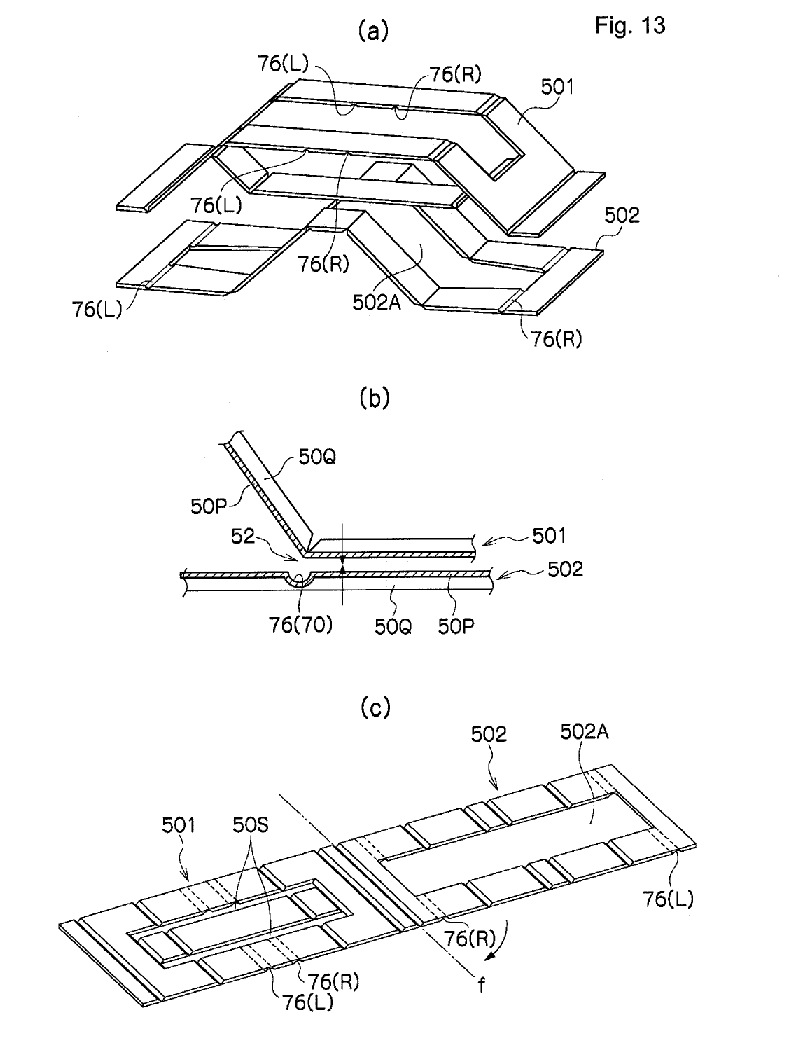

FIGS. 11, 12 and 13 are views illustrating other examples of the vibration direction converter part 50 (FIG. 11(a) is a side view, FIG. 11(b) is a perspective view, FIG. 12 is a view illustrating an operation and FIGS. 13(a) and 13(b) are views illustrating formation examples). The vibration direction converter part 50 (link body 50L) includes a pair of driving parts. In this embodiment, the vibration direction converter parts 50 are substantially symmetrically disposed opposite to each other and a parallel link is formed with a plurality of link parts.

The vibration direction converter part 50 includes a pair of first link parts 51A(R) and 51A(L) having a hinge part 52A(R) and 52A(L) to a first connecting part 53A (R) and 53A (L) at one end, and having a hinge part 52B(R) and 52B(L) to a second connecting part 53B at another end. Also, the vibration direction converter part 50 includes a pair of second link parts 51B(R) and 51B(L) having hinge parts 52C(R) and 52C(L) to the middle parts of the first link parts 51A(R) and 51A(L) at one end, and having hinge parts 52D(R) and 52D(L) to the static connecting part 53C at another end. As described above, the first connecting part 53A is connected to the voice coil 30 or the voice coil support part 40 directly or via the connecting part 60 as other member, while the second connecting part 53B is connected to the diaphragm 10 and the static connecting part 53C is connected to the bottom portion 12A of the frame 12 that is the static part 100, the yoke 22, etc. forming the magnetic circuit 20.

Further the vibration direction converter part 50 includes a pair of third link parts 51C(R) and 51C(L) having hinge parts 52E(R) and 52E(L) at one end to a pair of the connecting parts 53D(R) and 53D(L) integrally extending from the first connecting part 53A (R) and 53A (L), and having hinge parts 52F (R) and 52F (L) at another end to a connecting part 53E that is integral with the second connecting part 53B.

Further, the first link part 51A(R) and the third link part 51C(R), the first link part 51A(L) and the third link part 51C(L), the second link part 51B(R) and the third link part 51C(L), and the second link part 51B(L) and the third link part 51C(R) form parallel links respectively.

This link body 50L of the vibration direction converter part 50 substantially includes a function combining the link body of the embodiment shown in FIG. 7 and the parallel link body. Each link part and connecting part are formed by integrating the continuous member 50P with the rigid member 50Q, while each hinge part between link parts is linearly formed with the bendable continuous member 50P, and thus link parts are mutually integrally formed via hinge parts.

As shown in the drawings, the second connecting part 53B arranged near the hinge parts 52F (R) and 52F (L) and a pair of the connecting part 53D(R) and 53D(L) arranged near the hinge parts 52A(R) and 52A(L) form concave portions 76 as the contact avoiding part 70, such that a space is formed between each hinge part and connecting part.

An operation of the vibration direction converter part 50 is described with reference to FIG. 12. In this embodiment, the static connecting part 53C functions as the static part 100. According to the vibration direction converter part 50, when the hinge parts 52A(R) and 52A(L) is moved from the reference position X0 to X1 in the X-axis direction in accordance with vibration of the voice coil support part 40, the second connecting part 53B and the connecting part 53E integrally with the second connecting part 53B moving up keeping a parallel state by the parallel link body, while the first link parts 51A(R) and 51A(L) and the third link parts 51C(R) and 51C(L), which configure a parallel link, are angle-varied as they are erected. Since the hinge parts 52D(R) and 52D(L) are supported at both ends of the static connecting part 53C as the static part, they receive a reaction force from the static part and angle of the first link parts 51A(R) and 51A(L) and the third link parts 51C(R) and 51C(L) is securely varied and the displacement of the hinge parts 52A(R) and 52A(L) from the position X0 to X1 is securely converted to the displacement of the diaphragm 10 from the position Z0 to Z1.

Similarly, when the hinge parts 52A(R) and 52A(L) is moved from the reference position X0 to X2 in the X-axis direction, the second connecting part 53B and the connecting part 53E integrally with the second connecting part 53B are moved down keeping a parallel state by the parallel link body, while angles of the first link parts 51A(R) and 51A(L) and the third link parts 51C(R) and 51C(L), which configure a parallel link, are varied as they are laid. Since the hinge parts 52D(R) and 52D(L) are supported by the static part, they receives a reaction force from the static part and angle variation of the first link parts 51A(R) and 51A(L) and the third link parts 51C(R) and 51C(L) is securely produced and the displacement of the hinge parts 52A(R) and 52A(L) from the position X0 to X2 is securely converted to the displacement of the diaphragm 10 from the position Z0 to Z2.

According to this vibration direction converter part 50, the vibration in the X-axis direction of one voice coil support part 40 is converted to the vibrations in the Z-axis direction of the hinge parts 52B(R) and 52B(L), 52F (R) and 52F (L), and the second connecting part 53B, which vibrate substantially in the same phase and the same amplitude. As such, since the diaphragm 10 is supported over a large area and given the vibration that has substantially the same phase and the same amplitude, the vibration of the voice coil support part 40 may be transmitted substantially in the same phase to the planar diaphragm 10 with large area.

As shown in FIG. 11(b), in the vibration direction converter part 50, a pair of the connecting parts 53B, 53D(R) and 53D(L) and the third link parts 51C(R) and 51C(L) are disposed in a width direction and parallel respectively. The first link parts 51A(R) and 51A(L) are formed in a biforked shape, and the hinge parts 52C(R) and 52C(L) to the second link parts 51B(R) and 51B(L) are formed at the middle parts of the first link parts 51A(R) and 51A(L). The second link parts 51B(R) and 51B(L) and the connecting part 53C are placed between a pair of the connecting parts 53B, 53D(R) and 53D(L) and the third link parts 51C(R) and 51C(L), which are disposed in a width direction and parallel.

With link parts configured with a single sheet-shape component as described above, the diaphragm 10 can be vibrated and supported by a face, and thereby the whole diaphragm 10 can be vibrated substantially in the same phase and divided vibration may be restrained.

Further, as shown in FIG. 11(b), in the vibration direction conversion part 50 of this embodiment, the first link parts 51A(R) and 51A(L), and the second connecting parts 53B are configured by folding the whole single sheet-shape component forming the link parts in a convex-trapezoid shape, while the second link parts 51B(R) and 51B(L), and the static connecting part 53C are configured by folding a partially taken-out portion of this plate component.

A method of configuring this vibration direction converter part 50 is described with reference to FIG. 13. According to one configuration method, this vibration direction converter part 50 is formed by joining a plurality of sheet-shape components 501, 502 (for example, two components) as shown in FIG. 13(a). The first connecting parts 53A(R) and 53A(L), the first link parts 51A(R) and 51A(L), the second link parts 51B(R) and 51B(L), the second connecting parts 53B and the static connecting part 53C are formed in one sheet-shape component 501, while the connecting parts 53D, the third link parts 51C(R) and 51C(L) and the connecting parts 53E are formed in another sheet-shape component 502. And, the third link parts 51C(R) and 51C(L) and the connecting parts 53D(R) and 53D(L) are formed along the first link parts 51A(R) and 51A(L) and the second connecting parts 53B, and an opening 502A is formed in the sheet-shape component 502 corresponding to the second link parts 51B(R) and 51B(L) and the static connecting part 53C.

In this embodiment, the opening 502A, formed in another sheet-shape component 502 corresponding to the second link parts 51B(R) and 51B(L) and the static connecting part 53C of one sheet-shape component 501, is formed so as to expand inward from ends of another sheet-shape component 502. This configuration may prevent the second link parts 51B(R) and 51B(L), and the static connecting part 53C from contacting another sheet-shape component 502, and thus a smooth movement of the link body may be performed.

The two sheet-shape components 501 and 502, which are formed with the continuous member 50P and the rigid member 50Q, are applied with their continuous members 50P, 50P face-to-face as shown in FIG. 13(b). According to this arrangement, the continuous members 50P, 50P are integrated, and thereby hinge parts 52 may smoothly bend. Also in this case, the concave portion or the notch part 76 is formed as the contact avoiding part 70 near the hinge part 52.

Further, the slant face as shown in FIG. 5(c) is formed at the end of each link part near each hinge part. The slant face is formed such that the link parts do not interfere with each other when they bend at the hinge parts. Thus the link parts can efficiently bend at the hinge parts.

In another configuration example, the above-mentioned sheet-shape component 501 and the sheet-shape component 502 are integrally formed with the sheet-shape component 502 connected to the end of the sheet-shape component 501 as shown in FIG. 13(c). The vibration direction converter parts 50 shown in FIGS. 11 and 12 may be obtained by folding the integrated components along a folding line fin the direction of an arrow. In this example, the vibration direction converter part 50 may be simply configured by applying resin material forming the rigid member 50Q to the whole surface of the continuous member 50P that is a sheet-shaped member, cutting in a V-shape to form each hinge part and the slant faces at both sides thereof, and then forming the above-mentioned notch part 50S and opening 502A and hardening the resin material in the same way as shown in FIG. 10.

Further, when forming each hinge part and the slant faces 51t and 53t at the both sides thereof, the rigid member 50Q may be formed with the resin material and molded at the same time. It is preferable that a cross-sectional V-shape groove or a concave portion is preliminarily formed in a die, which is used to mold the rigid member 50Q.

In the vibration direction converter part 50 shown in FIGS. 8 to 13, since the link body of the vibration direction converter part 50 may be configured with a single integral component with respect to two opposing voice coil support parts 40, the assembly operation may be simplified as well when configuring a speaker device provided with a pair of driving parts. Further, provided with the static connecting part 53C, the hinge parts 52D(R) and 52D(L) may be held at fixed positions even if they are not particularly supported by the frame 12 corresponding to opposing vibrations of the voice coil support parts 40 (a plurality of the voice coil support parts 40 vibrate in directions opposite to each other), and thus the vibration direction converter part may be simply built into a speaker device.

Further, in the vibration direction converter part 50 shown in FIG. 11 to FIG. 13, since the right side first link part 51A(R) and the third link parts 51C(R), and the left side first link part 51A (L) and the third link parts 51C(L) form parallel links as the link body, the second connecting parts 53B fixed to the diaphragm 10 may be stably moved in parallel in the Z-axis direction corresponding to the opposing vibrations of the voice coil supporting parts 40. Accordingly, it is possible to apply stable vibrations to the planar diaphragm 10.

According to this speaker device 1, 1A, 1B, when an audio signal SS is inputted, the voice coil support part 40 vibrates along the magnetic gap 20G formed in a direction different from the vibration direction admissible for the diaphragm 10, and this vibration is direction-converted by the vibration direction converter part 50 and transmitted to the diaphragm 10, and thereby vibrating the diaphragm 10 to emit a sound in the sound emission direction SD corresponding to the audio signal SS.

Since the direction of the magnetic gap 20G is configured to cross the vibration direction of the diaphragm 10 and the thickness direction of the speaker device 1, 1A, 1B, increasing the driving force of the magnetic circuit 20 or the vibration of the voice coil 30 does not directly affect the size of the speaker device 1, 1A, 1B in the thickness direction (Z-axis direction). Accordingly, it is possible to make the speaker device 1, 1A, 1B thin while pursuing reproduced a louder sound.

Further, since the vibration direction converter part 50 converts the vibration direction of the voice coil support part 40 and transmits the vibration to the diaphragm 10 through the mechanical link body, transmission efficiency of vibration is high. In particular, in the speaker device 1, 1A, 1B shown in FIGS. 7 to 8, since angle variation of the first link parts 51A and the second link parts 51B is produced by the vibration of the voice coil support part 40 and reaction force of the static part 100, vibration of the voice coil support part 40 may be more securely transmitted to the diaphragm 100. Accordingly, the speaker device 1, 1A, 1B may produce preferable reproducing efficiency.

Further, in the speaker device 1, 1A, 1B shown in FIGS. 2, 7, and 8, provided with the connecting part 60, interval in the Z-axis direction may be provided between the position of the end 40A of the voice coil support part 40 and the position of the end 50A of the vibration direction converter part 50. As such, the length (height) in the Z-axis direction (thickness) of the magnetic circuit 20 can be included in the length in the Z-axis direction of the vibration direction converter part 50, and thus the speaker device 1, 1A, 1B may be made thin while securing a sufficient length in the Z-axis direction for the magnetic circuit 20, which is required to secure a driving force. Further, provided with the connecting part 60, a necessary length of the direction converter part 50 (length of link parts 51) may be sufficiently secured even if the speaker device 1, 1A, 1B is made thin, and thus the amplitude of vibration of the diaphragm 10 may be comparatively large.

More particularly, a bottom portion 61 of the connecting part 60 is configured to slide over the bottom portion 12A of the frame 12 or the static part 100 with a predetermined distance therefrom, and thereby vibration of the voice coil support part 40 may be stabilized. Further, the end of the vibration direction converter part 50 can be linearly moved, and thus the end of the vibration direction converter part 50 connected to the diaphragm 10 can be securely and stably moved.

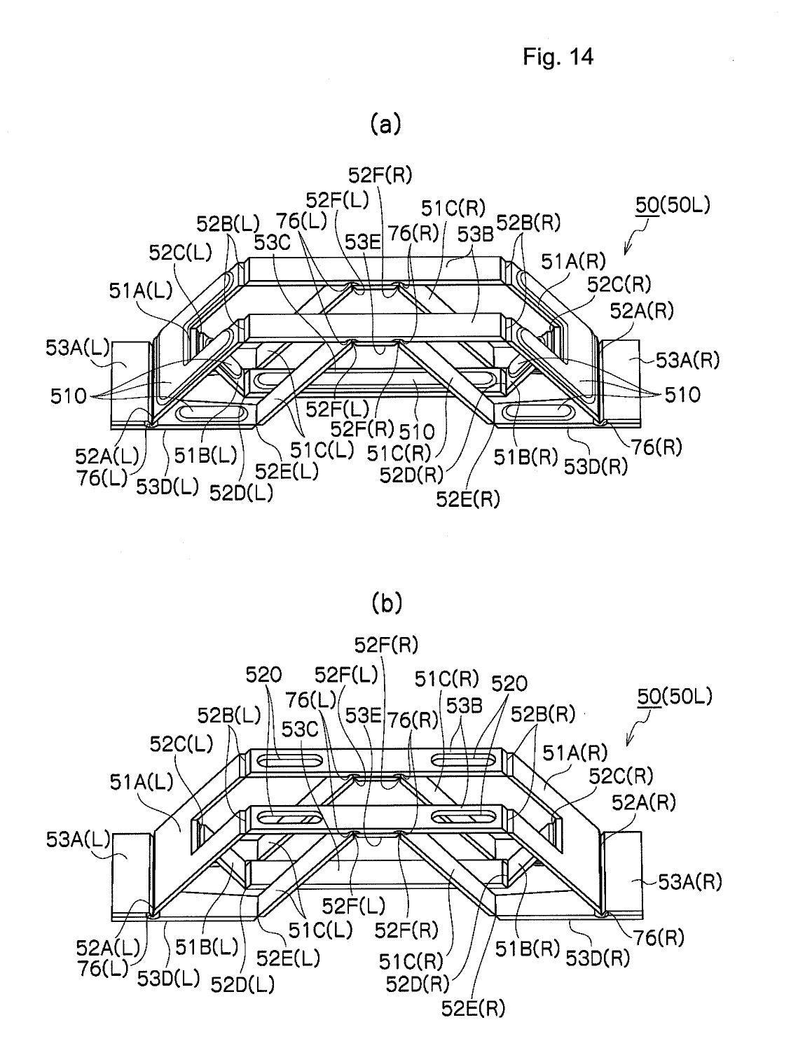

The vibration direction converter part 50 shown in FIG. 14 is a modified example of the embodiment shown in FIG. 11. In one example shown in FIG. 14(a), a convex portion 510 is provided on the link part that are subject to bend by opposing vibrations of the voice coil supporting parts 40, thereby rigidity of the link part can be increased. As shown in the drawing, the first link part 51A(R) and 51A(L), the second link parts 51B(R) and 51B(L), the connecting parts 53D(R) and 53D(L) and the connecting part 53C are provided with the convex portion 510 respectively. Further, in one example shown in FIG. 14(b), openings 520 are provided in the link part that need no particular strength, weight of the vibration direction converter part can be decreased. In the drawing, the connecting part 53B includes the openings 520. The weight reduction of the vibration direction converter part is effective to broaden a reproduction characteristic or increase amplitude and a sound pressure level of a sound wave corresponding to predetermined voice currents.

### [Holding Part]

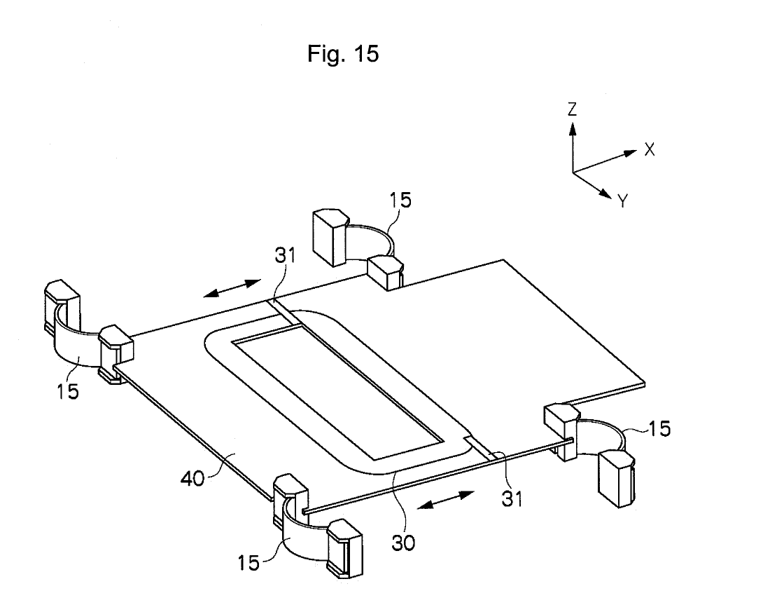

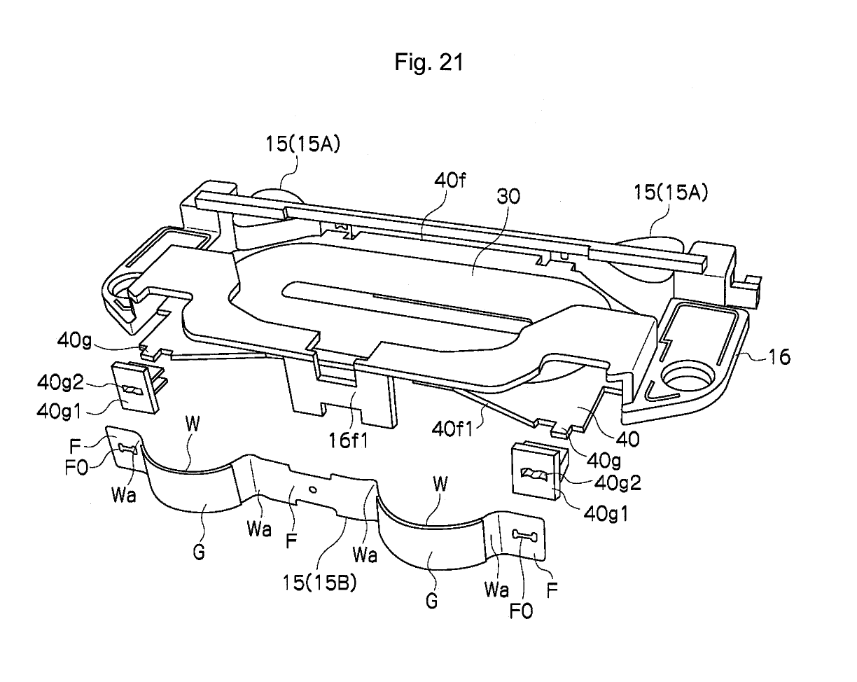

FIGS. 15 to 27 are views illustrating a holding part of the speaker device according to an embodiment of the present invention. The holding part 15 holds the voice coil 30 at the static part and restricts the vibration of the voice coil 30 in one axis direction. Here, restricting the vibration of the voice coil 30 in one axis direction by the holding part 15 means restraining the vibration of the voice coil 30 in the vibration direction of the diaphragm, and the voice coil 30 may be allowed to vibrate somewhat in the vibration direction of the diaphragm.

With this holding part 15, it is possible to prevent the voice coil 30 vibrating in the vibration direction of the diaphragm from contacting the configuring member of the magnetic circuit (plate, yoke, etc.) or the frame and restrain a trouble such as generation of an abnormal noise due to the contact. In order to restrict the vibration of the voice coil 30 in one axis direction as described above, the holding part 15 is preferably elastically deformable in an allowable vibration direction and has rigidity in other directions.

According to the example shown in FIG. 15, the voice coil 30 is supported by the voice coil support part 40, and the voice coil support part 40 is vibratably held at the static part. In the example shown in the drawing, the voice coil 30 is allowed to vibrate in the X-axis direction and is restrained to vibrate in the Y axis and Z-axis directions. In the example shown in the drawing, although four holding parts 15 are provided at the diagonal positions of the voice coil 30, the number of the holding parts 15 is not limited to four and three or more holding parts 15 may be provided on each right and left side. In order to allow the voice coil 30 to vibrate in the X-axis direction and restrain it to vibrate in other directions, the holding parts 15 may be preferably symmetrically provided with respect to the central axis of the voice coil 30 in the X-axis direction. The holding part 15 has elasticity with respect to the vibration of the voice coil 30 in the X-axis direction, and it holds the voice coil 30 in a neutral position when an electromagnetic force is not applied on the voice coil 30. Lead wires 31 are connected at both ends of the voice coil 30.

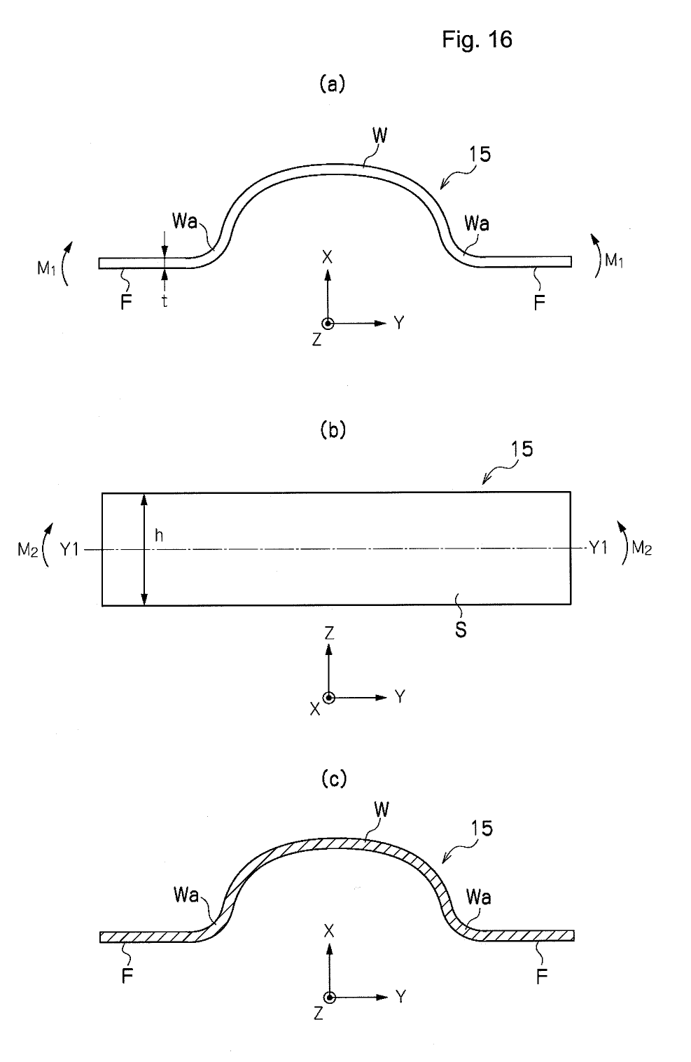

FIG. 16 is a view illustrating a single holding part 15 (FIG. 16(a) is a plan view, FIG. 16 (b) is a side view and FIG. 16(c) is a cross-sectional view taken along Y1-Y1 of FIG. 16(b)). The holding part 15 is formed in a plate shape and includes a curved portion W, Wa. The holding part 15 shown here is a plate shape member with thickness t and width h. With small thickness t with respect to width h, directional property in a certain direction can be provided to allowable elastic deformation.

The curved portion W, Wa of the holding part 15, which has a concavo-convex cross-sectional shape in the vibration direction of the voice coil 30 (X-axis direction), have a constant form in the vibration direction of the diaphragm 10 (Z-axis direction). More specifically, no matter how Y1-Y1 cross sectional axis is displaced in a parallel fashion, a cross-sectional view shown in FIG. 16 (c) is the similar shape. Accordingly, the curved portion W, Wa has side faces S linearly extending in the vibration direction of the diaphragm 10 (Z-axis direction), and the cross sectional face of the holding part 15 in the Z-axis direction is a constant rectangular cross sectional face with thickness t and width h. According to an aspect of the shape, the holding part 15 has smaller bending rigidity in the vibration direction of the voice coil 30 (X-axis direction) or bending around Z-axis than that in the vibration direction of the diaphragm (Z-axis direction) or bending around X-axis. More particularly, the holding part 15 is subject to deformation against a bending moment M₁ shown in FIG. 16(a), while it is not subject to deformation against a bending moment M₂ shown in FIG. 16 (b). Bending rigidity against the bending moment M₂ is increased with the curved portion W, Wa compared to a flat holding part 15.

The holding part 15 includes the curved portion W as a first curved portion and the curved portion Wa as a second curved portion, which is formed continuing to the first curved portion W. The radius of curvature of the second curved portion Wa is smaller than the radius of curvature of the first curved portion W. Further, the projection directions of the first curved portion W and the second curved portion Wa are opposite each other. A plurality of the curved portions W, Wa are concave and convex in the vibration direction (X-axis direction) of the voice coil 30. Therefore the holding part 15 has high compliance with respect to the vibration in the vibration direction of the voice coil 30. As such, a relationship between the driving force of the voice coil 30 and the displacement of the voice coil 30 can be made linear within a practical vibration range of the voice coil 30. Further, provided with the second curved portion Wa having the radius of curvature smaller than that of the first curved portion W, torsional rigidity of the holding part 15 may be increased. As such, generation of rolling of the voice coil 30 (vibration of the voice coil in the vibration direction of the diaphragm 10) may be restrained.

According to the example shown in the drawing, the holding part 15 has a tabular portion F having a linear cross-sectional shape at least at its end, and the tabular portion F is formed continuing to the curved portion Wa. The tabular portion F is provided to fix the holding part 15 on the side of voice coil or on the side of the static part. The holding part 15 may be stably fixed and supported by providing with the tabular portion F that is difficult to deform and deforming mainly the curved portion W, Wa with respect to the vibration of the voice coil 30.

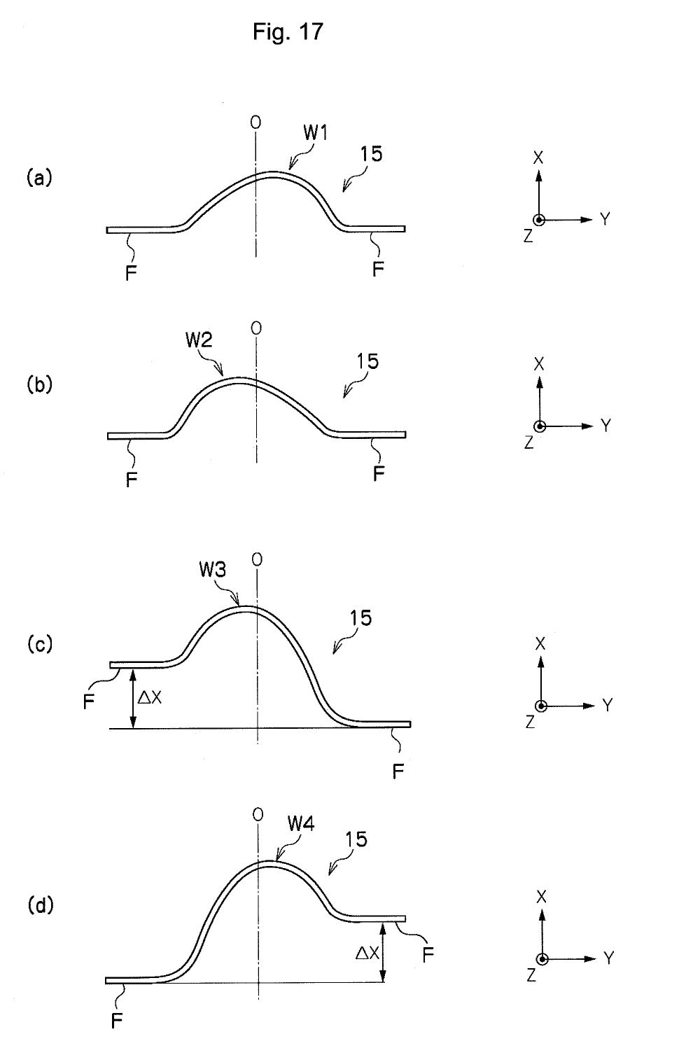

FIG. 17 is a view illustrating forming examples of curved portions of the holding part 15. According to these examples, a top of the curved portion W (W1 to W4) of the holding part 15 is formed displaced with reference to the center position O in the vibration direction of the voice coil 30 (X axis-direction). In FIGS. 17 (a) and 17(d), the tops W1 and W4 are formed displaced on the side of the static part, and in FIGS. 17 (b) and 17(c), the tops W2 and W3 are formed displaced on the side of the voice coil. Further, in FIGS. 17(a) and 17(b), the right and left positions in the X axis-direction of above-mentioned tabular portion F are the similar, while in FIGS. 17(c) and 17(d), the right and left positions in the X axis-direction of above-mentioned tabular portion F are different by ΔX. In this way, following performance of the holding part 15 to the vibration of the voice coil 30 is adjustable by displacing the position of top (W1 to W4) of the curved portion W, or differentiating the right and left positions of the tabular portion.

For example, as shown in FIGS. 17(a) and 17(d), the lengths from the voice coil 30 to the tops W1, W4 (way in the shape of the holding part 15) can be made large by displacing the top position W1 and W4 on the side of the static part with reference to the center position O, and thus the allowable range of the elastic deformation of the holding part 15 with respect to the vibration of the voice coil 30 may be widened. Therefore, the trouble may be avoided that restoration of shape of the holding part 15 is lost due to the deformation of the holding part 15 beyond a yield point when the voice coil 30 vibrates at large amplitude of the vibration.

As shown in FIGS. 17 (c) and 17(d), when the difference ΔX is provided between the position of the tabular portions F on the right side and the left side, elastic force of repulsion of the holding part 15 may be changed between the forward and backward vibrations in the forward and backward vibrations of the voice coil 30 in the X axis-direction. In the holding part 15 in which the top of the curved portion W is formed on the one side, elastic force of repulsion of the holding part 15 becomes asymmetrical between the forward and backward vibrations of the voice coil 30. With the difference ΔX between position of the tabular portions F on the right side and the left side, modifications of dissolving or strengthening asymmetry may be applied to this asymmetrical elastic force of repulsion.

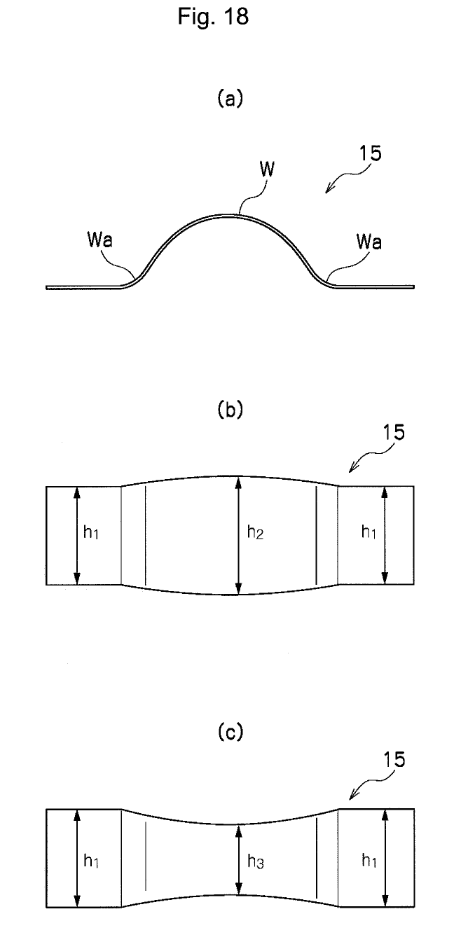

FIG. 18 is a view illustrating other forming examples of the curved portions of the holding part 15. FIG. 18(a) is a plan view, FIG. 18(b) is a side view of an example and FIG. 18(c) is a side view of another example. In the curved portion W of the holding part 15, the width h2 of the curved portion W may be gradually increased compared to the width h1 of the flat part F as shown in FIG. 18(b), or the width h3 of the curved portion W may be gradually decreased compared to the width h1 of the flat part F as shown in FIG. 18(c). As such, degree of compliance of the holding part 15 may be made adjustable by adjusting the width of the curved portion W.

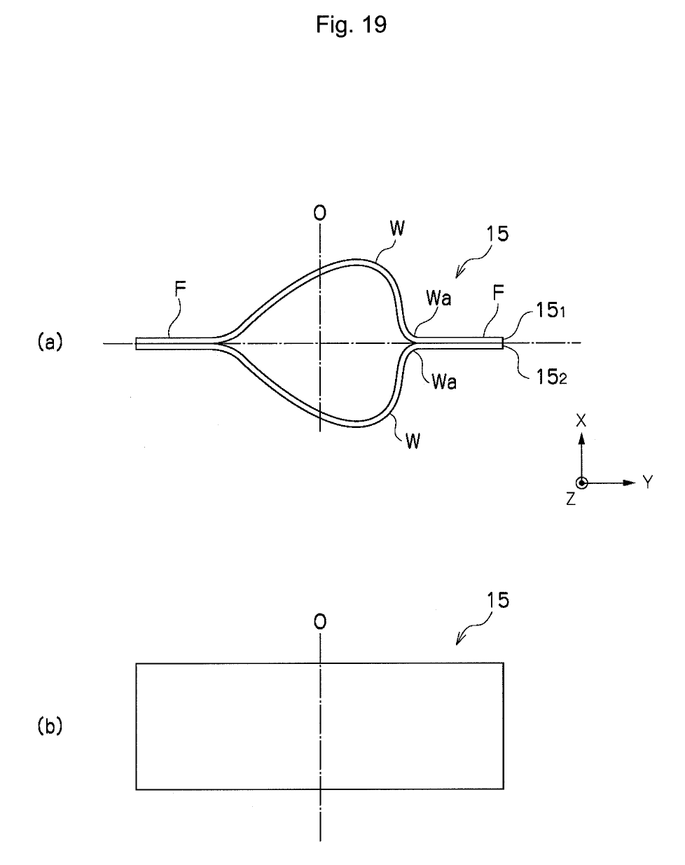

FIG. 19 is a view illustrating another configuration example of the holding part 15 (FIG. 19(a) is a plan view and FIG. 19(b) is a side view). The holding part 15 of this example is deformable in the vibration direction (X axis-direction) of the voice coil and has rigidity in the vibration direction (Z axis-direction) of the diaphragm, and is formed with a plurality of configuring members. According to the example shown in the drawing, the holding part 15 is formed by joining two configuring members 15₁ and 15₂. Configuring members 15₁ and 15₂ each include the curved portion W as the first curved portion and the second curved portion Wa continuously formed from the first curved portion W. The radius of curvature of the second curved portion Wa is formed smaller than the radius of curvature of the first curved portion W. The projection directions of the first curved portion W and the second curved portion Wa are opposite to each other. Further, in each of configuring members 15₁ and 15₂ the top of the curved portion W is displaced in the side of the static part with reference to the center position O in the vibration direction of the voice coil 30 (X axis-direction), and include a tabular portion F with linear cross-sectional shape at least at the end and the tabular portion F is continuously formed from the curved portion Wa.

And, the plurality of the configuring members 15₁ and 15₂ are arranged opposite each other, and a space surrounded by the configuring members 15₁ and 15₂ is formed between the configuring members 15₁ and 15₂. Torsional rigidity of the holding part 15 is increased by this space, and thus generation of a rolling phenomenon (vibration of the voice coil 30 in the vibration direction of the diaphragm 10) may be restrained. Further, the holding part 15 including the configuring members 15₁ and 15₂ has substantially a line-symmetrical shape. With this line-symmetrical shape of the configuring members 15₁ and 15₂, symmetry of the voice coil 30 in forward and backward vibrations may be secured. Further, when the configuring members 15₁ and 15₂ are made asymmetrical, a balance of the voice coil 30 in forward and backward vibrations may be adjustable by making larger or smaller vibrations in one side than in the other side with reference to the neutral position. As shown in FIG. 19(b), the holding part 15 is formed in a rectangular shape when viewed from the side surface.

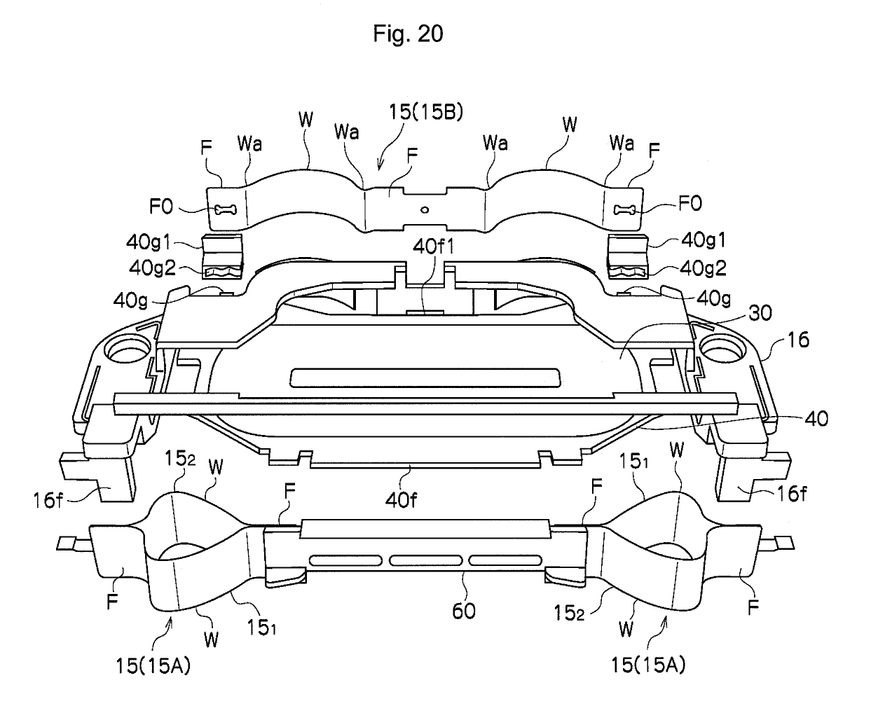

FIGS. 20, 21 and 22 are views illustrating embodiments of the unitized holding part. There is provided the connecting part 60, which connects the voice coil 30 or the voice coil support part 40 to the above-mentioned vibration direction converter part 50. An interval in the vibration direction of the above diaphragm 10 is formed between the end portion in the side of the above vibration direction converter part 50 of the voice coil 30 and the end portion in the side of the voice coil 30 of the vibration direction converter part 50. The connecting part 60 connects both end portions (see FIG. 7). And, the holding parts 15 (the first holding parts 15A) are connected to both right and left end portions of the connecting part 60, and the above-mentioned tabular portion F of the holding part 15 (15A) is connected to the connecting part 60 directly or via other member. In this embodiment, the holding part 15, which is made by substantially line-symmetrically connecting the configuring members 15₁ and 15₂ as described above, is used such that the tabular portion F in the side of one end portion of the holding part 15 is connected to the end portion of the connecting part 60, while the tabular portion F in the side of the other end of the holding part 15 is connected to the static part directly or via other member such as adhesive resin. By connecting the holding part 15 to the connecting part 60 via other member such as adhesive resin, fracture of the holding part 15 and generation of abnormal noise due to unwanted vibration transmitted to the holding part 15, may be restrained.

The voice coil 30 or the voice coil support part 40 includes an end edge 40f extending in the direction crossing the vibration direction of the voice coil 30 in the one end portion and the other end portion of the voice coil 30 in the vibration direction, and the end edge 40f is supported by the static part via the holding part 15. More specifically, the end edge 40f is connected to the connecting part 60, and the tabular portion F in the side of one end portion of the holding part 15 is connected to both right and left end portions of the connecting part 60 and the tabular portion F in the side of the other end portion of the holding part 15 is supported to the static part.

The speaker device includes an attachment unit 16 arranging the voice coil 30 or the voice coil support part 40 at a prescribed position with respect to the static part. One end portion of the holding part 15 (tabular portion F) is connected to the end edge 40f of the voice coil 30 or the voice coil support part 40 directly or via other member, while the other end portion (tabular portion F) is connected to the attachment unit 16 directly or via other member. More specifically, the tabular portion F in the side of one end of the holding part 15 is connected to the end edge 40f via the connecting part 60, and the tabular portion F in the side of the other end portion of the holding part 15 is connected to a connecting end 16f of the attachment unit 16. By using this attachment unit 16, steps of attaching the voice coil 30 to the static part via the holding part 15 may be simplified.

The holding part 15 (the second holding part 15B), holding at the static part the end edge 40f1 of the voice coil 30 or the voice coil support part 40 in the opposite side of the vibration direction converter part, includes a pair of the curved portions W, W, and is an integral part arranged in the direction that the end edge 40f1 of the voice coil 30 or the voice coil support part 40 extends. Both end portions (tabular portion F) of the second holding part 15B as the integral part are connected to the end edge 40f1 of the voice coil 30 or the voice coil support part 40, and a part of the second holding part 15B as the integral part (tabular portion F) as the integral part between a pair of the curved portions W, W is connected to the attachment unit 16.

The second holding part 15B includes a pair of the curved portions W, W as the first curved portion W and the second curved portion Wa whose outer shape is smaller than the first curved portion W. The second curved portion Wa is continuously formed from the first curved portion W and the projection directions of the first curved portion W and the second curved portion Wa are opposite each other.

A reinforcing member G is attached to the second holding part 15B as the integral part. The reinforcing member G is a member causing an internal loss with respect with the second holding part 15B as the integral part. With this reinforcing member G attached to the holding part, generation of a sound wave due to vibration of the holding partmay be restrained. In particular, generation of a sound wave due to resonance of the holding part 15 may be restrained. Further, with this reinforcing member G formed in a stacking structure, a function of damping vibration of the holding part 15 may be added. Further, with this reinforcing member G attached to a portion subject to fracture due to deformation of the holding part 15, fracture may be restrained. This reinforcing member G may be formed with a fiber member such as unwoven fabric or fabric, resin member such as rubber or polyurethane resin, or elastic member such as resin member having a foamed structure.

The second holding part 15B as the integral part and the attachment unit 16 are connected via adhesive resin. The tabular portions F, F at both right and left end portions of the second holding part 15B are connected to contacting parts 40g, 40g at both right and left end portions of the end edge 40f1 via connecting parts 40g1, 40g1 having holes 40g2 respectively, and the tabular portion F in the center of the second holding part 15B is connected to the connecting end portion 16f1 of the attachment unit 16. The end edge 40f1 of the voice coil support part 40 in the opposite side of the vibration direction converter part of the voice coil support part 40 is formed in a concave shape with respect to the voice coil 30, and the voice coil support part 40 is formed in a planar shape restraining contact with the attachment unit 16, when the voice coil supporting part 40 is vibrated due to vibration of the voice coil 30. More specifically, in the voice coil support part 40, a comparatively large interval is formed between the connecting end portion 16f1 of the attachment unit 16 and the end edge 40f1 of the voice coil support part 40, and the voice coil support part 40 has a planar shape projecting toward the second holding part 15B as coming near the both right and left flat parts F of the second holding part 15B. Holes, in which contacting parts 40g of the right and left end portions of the other end edge 40f1 in the voice coil support part 40 are inserted, are formed in the flat parts F at both right and left end portions of the second holding part 15B.

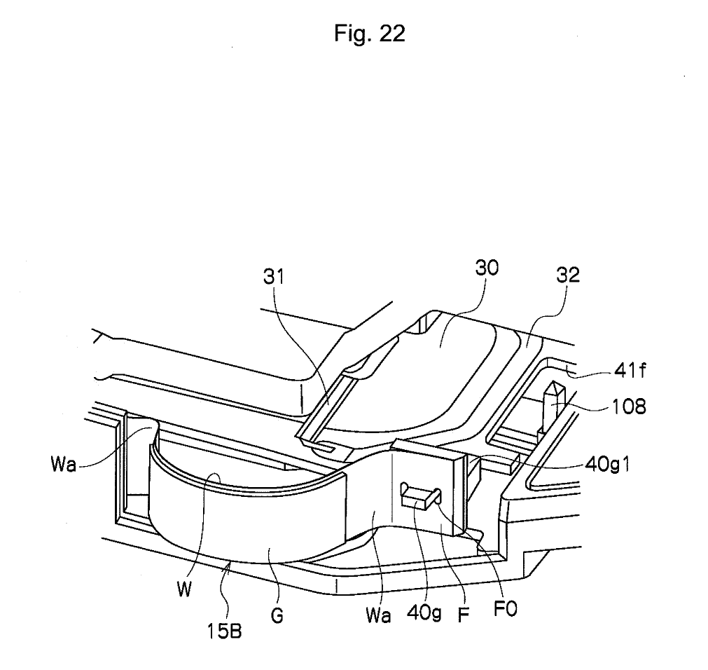

FIG. 22 is a view illustrating the second holding part 15B connected to the contacting part 40g. The second holding part 15 is connected to the voice coil support part 40 with the convex portion of the contacting part 40g fitted in or inserted into a hole 40g2 of a component 40g1 and a hole FO of the tabular portion F.

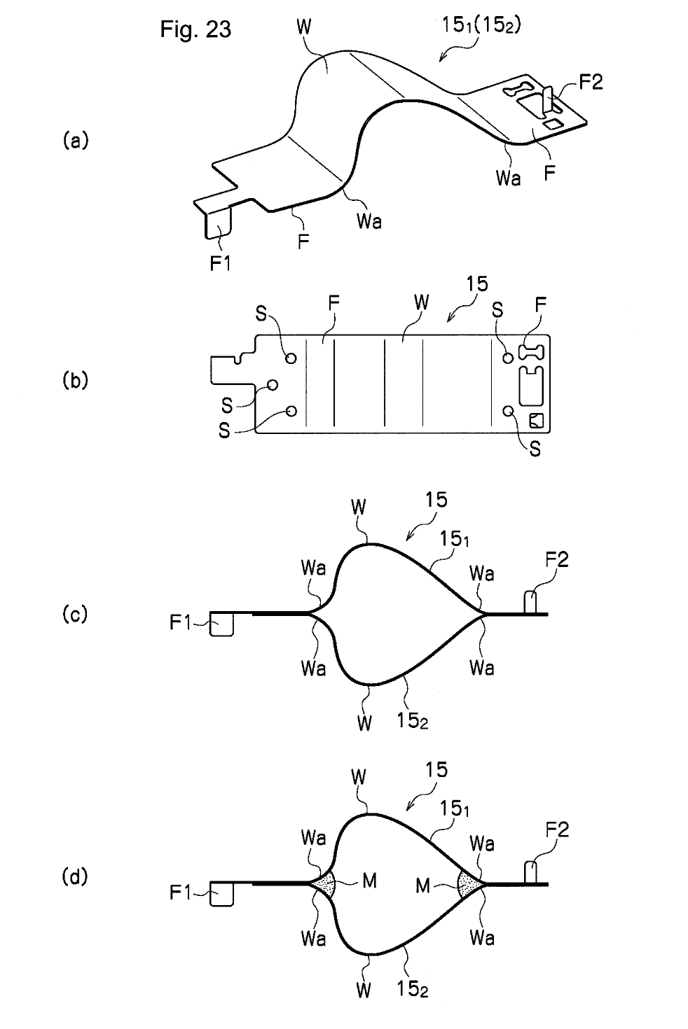

FIG. 23 is a view illustrating a specific formation example of the holding part 15 formed by joining the configuring members 15₁ and 15₂. FIG. 23 (a) is a perspective view showing a separate configuring member 15₁ or 15₂. FIG. 23(b) is a side view of the holding part 15 and FIG. 23(c) is a plan view thereof. Further, FIG. 23(d) is a modified example thereof. The configuring member 15₁ (15₂) of the holding part 15 are contacted with each other at their tabular portions F, including the first curved portion W and the second curved portion Wa, and the tabular portions F, F at both end portions, including connecting faces F1 and F2 orthogonal to the tabular portion F. A plurality of the configuring members 15₁ and 15₂ are metal members and joined by welding. According to an example shown in the drawing, the configuring members 15₁ and 15₂ are welded by applying a spot welding to the tabular portions F, F while facing each other. In this example, spot weldings are applied to a plurality of spots at each of tabular portions F, F of both end portions (symbols s show spots of spot welding). By forming the holding part 15 with the two configuring members 15₁ and 15₂ joined together, torsion of the holding part 15 or generation of resonance in the holding part 15 may be restrained. As shown in FIG. 23(d), an elastic member M such as adhesive resin, silicone-system resin, etc. may be provided near the face where the two configuring members 15₁ and 15₂ constructing the holding part 15 are combined, in order to cause an internal loss.

Further, by forming the holding part 15, for example, substantially in a symmetrical shape, while the two configuring members 15₁ and 15₂ having substantially the same shape are disposed opposite each other, performance of the holding part 15 (stiffness symmetry during the vibration stroke) may be improved. Here, “stiffness symmetry during the vibration stroke” means symmetry of the stiffness curve when a voice coil moves in one direction and the stiffness curve when the voice coil moves in another direction.

FIG. 24 is a perspective view illustrating an example of supplying a voice coil with a signal via the holding part 15. In this example, a holding part 15 made of a metal material having conductivity is used for a plurality of the configuring members 15i and 15₂, and this holding part 15 is a part of wiring. The voice coil 30 and the voice coil support part 40 are attached to the static part 100 via the attachment unit 16. A pair of the voice coil 30 or the voice coil support part 40 are connected to the vibration direction converter part 50 via the connecting part 60. The first holding part 15A has one end portion connected to the connecting part 60, and an other end portion supported by the attachment unit 16. The second holding part 15B has both end portions connected to both right and left end portions of the voice coil 30 or the voice coil support part 40, and the central part connected to the attachment unit 16.

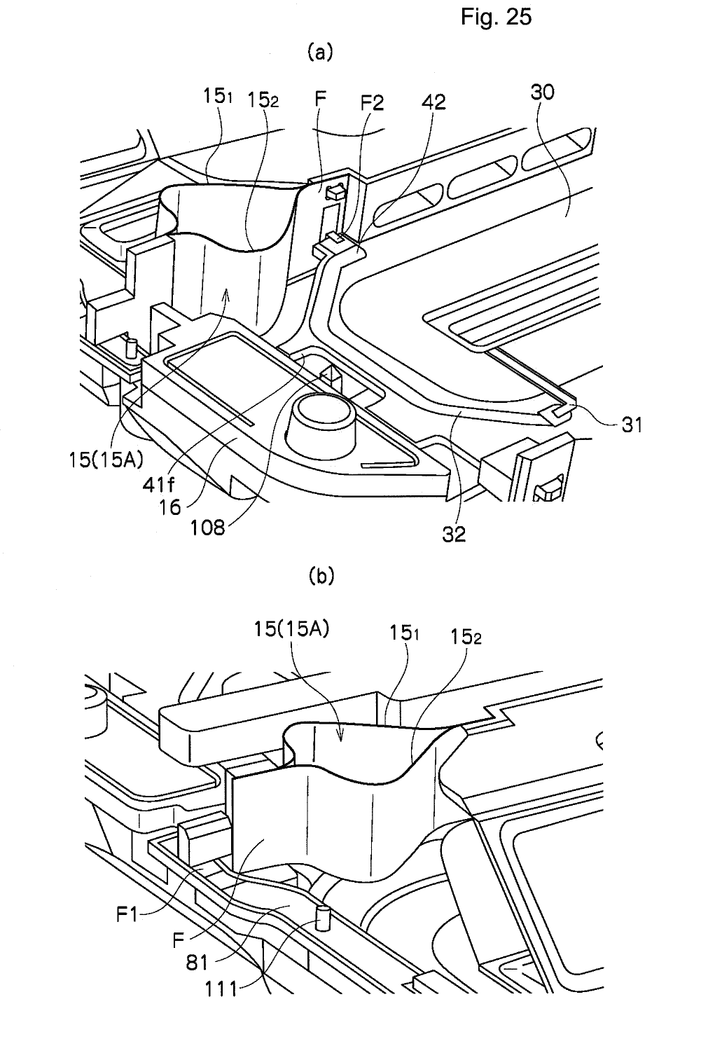

FIG. 25 is a partial enlarged view of FIG. 24. FIG. 25(a) is an enlarged view of part 24A of FIG. 24, and FIG. 25(b) is an enlarged view of part 24B of FIG. 24. Part 24C in FIG. 24 is symmetrical to part 24A in FIG. 24, and thus its enlarged view is not shown. FIG. 25(a) shows in detail that one connecting face F2 of the first holding part 15A is connected to a connect terminal part 42 of a voice coil lead wire 32 (conducting layer). FIG. 25(b) shows in detail that another connecting face F1 of the first holding part 15A is connected to a terminal part 81.

The first holding part 15A has a connecting face F1 in the side of one end portion connected to the terminal part 81, and a connecting face F2 in the side of another end portion connected to the connect terminal part 42 of the voice coil lead wire 32. The terminal part 81 connects a pair of the first holding part 15A in the side of one end electrically to a wiring 82 (external), and an audio signal inputted from the wiring 82 is supplied to a voice coil lead wire 32 via the terminal part 81 and the first holding part 15A. The terminal part 81 is a conducting member formed in a rod shape. The terminal part 81 has a positioning hole. And the terminal part 81 is positioned at a specified location of the static part 100 with this positioning hole inserted by a positioning projection 111 provided at the static part 100. Further, a part of the terminal part 81 is insulated, and a surface of conducting member in a region where connecting with the connecting face F1 of the first holding part 15A is exposed so as to be electrically connectable to the first holding part 15A. Further, the terminal part 81 may be electrically connected to the connecting face F1 of the holding part 15 by constructing the terminal part 81 with an insulating member such as resin member, etc. and providing a conducting member on this insulating member.

When configuring the holding part 15 with a plurality of configuring members, one configuring member may be made of a rigid material and another configuring member may be made of a material causing an internal loss. As a material causing an internal loss, resin material such as rubber, polyurethane resin, etc. or a resin member having a foamed structure, are included. By configuring the holding part with a plurality of configuring members different in property, performance of vibration of the holding part may be improved. Further, since the resonant frequency is different among the configuring members, generation of resonance may be restrained at the joining face where a plurality of configuring members are joined, and thus generation of abnormal noise may be restrained. As this holding part 15, for example, the second holding part 15B to which the above-mentioned reinforcing member G is attached, is included. Further, not limited to the above embodiment, the second holding part 15B may be connected to the attachment unit 16, sandwiching another configuring member causing an internal loss between the second holding part 15B and the attachment unit 16.

Further, a resin member such as rubber with a metal member arranged inside may be used as a plurality of configuring members of the holding part 15, or different metal members may be used as the plurality of configuring members. There is no particular limit to the configuration. In the former example, internal loss may preferably be generated since a metal member is covered with a resin member. In the latter example, since the resonance frequency is different from each other, generation of resonance may be restrained at a joining face where a plurality of metal members are joined.

As shown in FIG. 23(c), an elastic member such as adhesive resin, silicone-system resin, etc. may be provided near the face where the two configuring members 15₁ and 15₂ constructing the holding part 15 are joined, in order to cause internal loss. More specifically, an elastic member such as adhesive resin, silicone-system resin, etc. may be provided in a space formed between the second curved portions Wa opposite each other of the holding part 15.

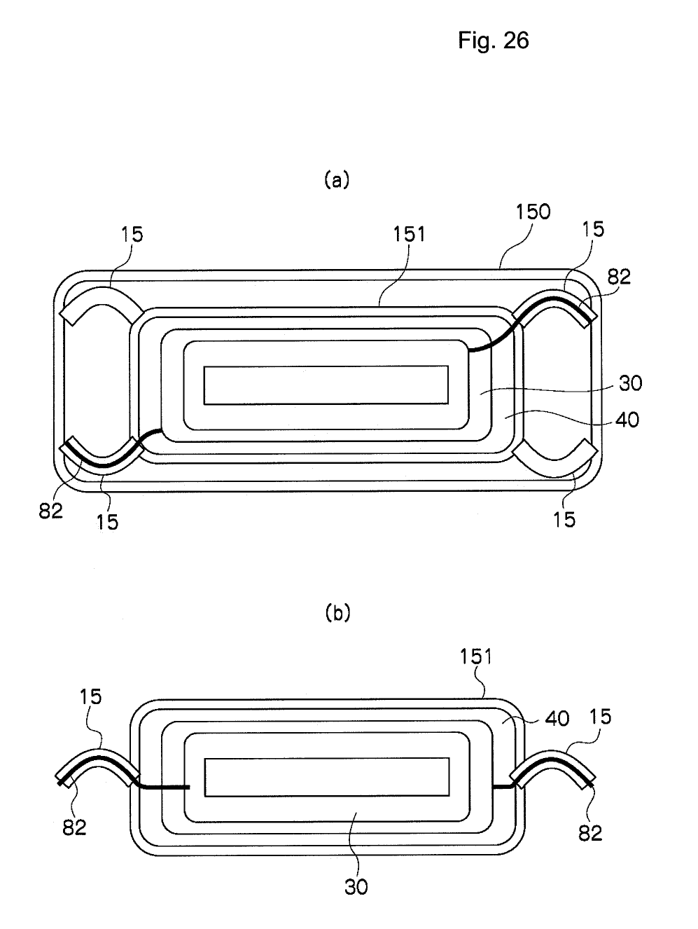

FIG. 26 shows a modified example of a holding structure of the holding part. According to an example shown in FIG. 26 (a), a holding structure that a damper so-called butterfly damper supports the voice coil 30 at the static part, is shown. The damper is formed in a tabular shape principally using an elastically deformable resin member or metal member. The holding structure shown in the drawing includes an annular shape part 150 surrounding the voice coil 30, and the inner periphery part of the holding part 15 is connected to the voice coil 30 directly or via other member (voice coil support part 40, annular shape part 15₁), and the outer periphery part of the holding part 15 is connected to the static part 100 via the annular shape part 150. According to the example shown in FIG. 26 (b), the outer periphery of the voice coil 30 or the voice coil support part 40 is supported by the annular shape part 15₁. The inner periphery part of the holding part 15, whose outer periphery part of the holding part 15 is supported by the static part, is supported by the annular shape part 15₁. The annular shape part 15₁ is made of so-called damper members, which are made of, for example, unwoven fabric or fabric made of synthetic fiber, etc. or fiber members of unwoven fabric or fabric impregnated with adhesive resin such as phenol resin, an elastically deformable resin member, rubber or metalmember. Further, the annular shape part 15₁ is preferably formed to have rigidity (including bending rigidity) in the vibration direction of the diaphragm 10 as necessary. Further, a wiring 82 is arranged along the holding part 15.

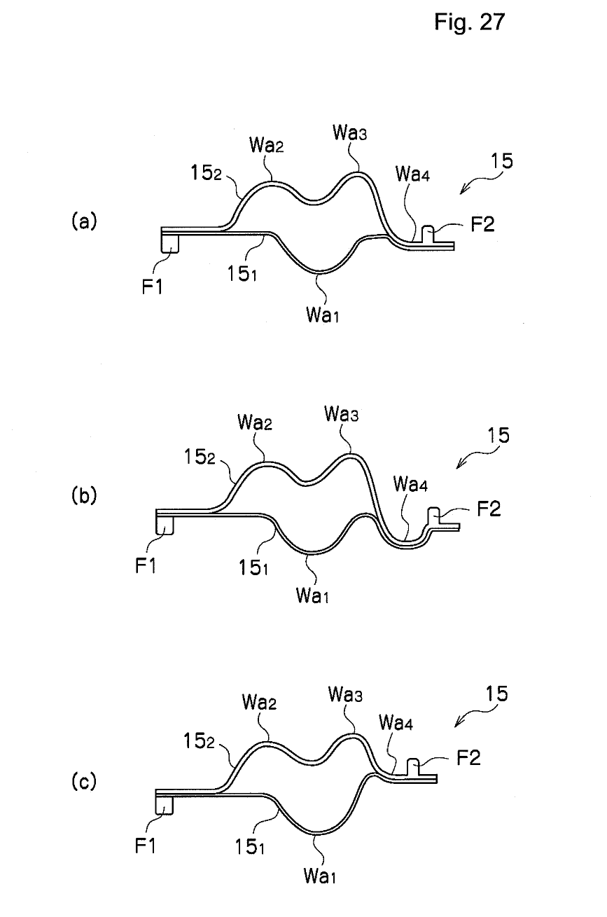

FIG. 27 shows a modified example of the holding part. In this example, the holding part 15 is a damper including a rigid member holding the voice coil 30 at a prescribed height with respect to the static part 100. The rigid member may be constructed with a resin member. Further, the damper is constructed with a fiber member and adhesive resin applied to the surface or inside of the fiber member, providing the fiber member with rigidity. In the example shown in the drawing, although the damper includes a single curved portion, it may include a plurality of curved portions. Further, the holding part 15 may be formed with a plurality of metal members, for example, two plate shaped metal members with a curved cross-section as a rigid member.

Any dampers shown in the drawings are formed with a plurality of the configuring members 15₁ and 15₂. One configuring member 15₁ includes at least a first curved portion Wa1. Another configuring member 15₂ includes a first curved portion Wal, a second curved portion Wa3 and a third curved portion Wa4.

In the example shown in FIG. 27 (a), the configuring members 15₁ and 15₂ are joined at substantially the same height. In the example shown in FIG. 27 (b), the inner periphery part of the configuring member 15₂ is located on the opposite side of projected curved portion of the configuring member 15₂ with respect to the outer periphery part of the configuring member 15₂ compared to the example shown in FIG. 27 (a). In the example shown in FIG. 27 (c), the inner periphery part of the configuring member 15₂ is located in the side of projected curved portion of the configuring member 15₂ with respect to the outer periphery part of the configuring member 15₂ compared to the example shown in FIG. 27 (a).

As shown in each example, performance of damper (stiffness symmetry during the vibration stroke) may be adjustable by changing the vertical position of the inner periphery part of the configuring member 15₂. Here, “stiffness symmetry during the vibration stroke” means symmetry of the stiffness curve when a voice coil vibrates in one direction and the stiffness curve when the voice coil vibrates in another direction.

The “stiffness symmetry during the vibration stroke” is improved when the position of the inner periphery part of the configuring member 15₂ is elevated on the condition that the configuring member 15₂ is connected above the configuring member 15₁ and the configuring member 15₂ is projected upward. If the position of the inner periphery part of the configuring member 15₂ is lowered, stiffness asymmetry of vertical vibration (asymmetry between the stiffness curve when a voice coil vibrates in one direction and the stiffness curve when the voice coil vibrates in another direction) becomes large. In the example shown in the drawing, although one configuring member 15₁ is arranged in the side of the vibration direction converter part 50 and the other configuring member 15₂ is arranged in the side of the voice coil 30, one configuring member 15₁ may be arranged in the side of the voice coil 30 and the other configuring member 15₂ may be arranged in the side of the vibration direction converter part 50 as necessary.

### Embodiments and Mounting Examples

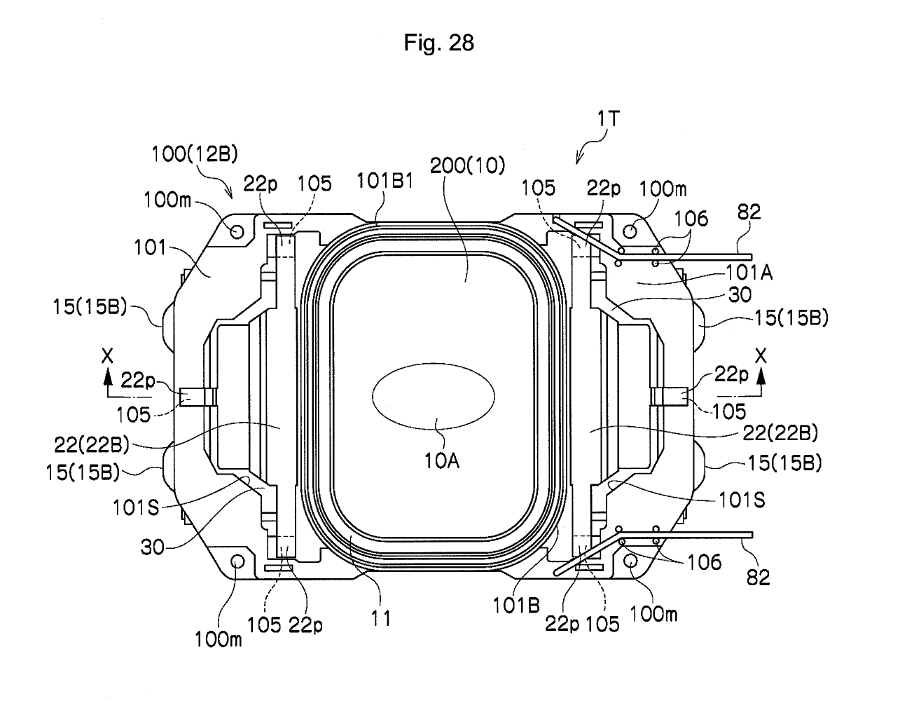

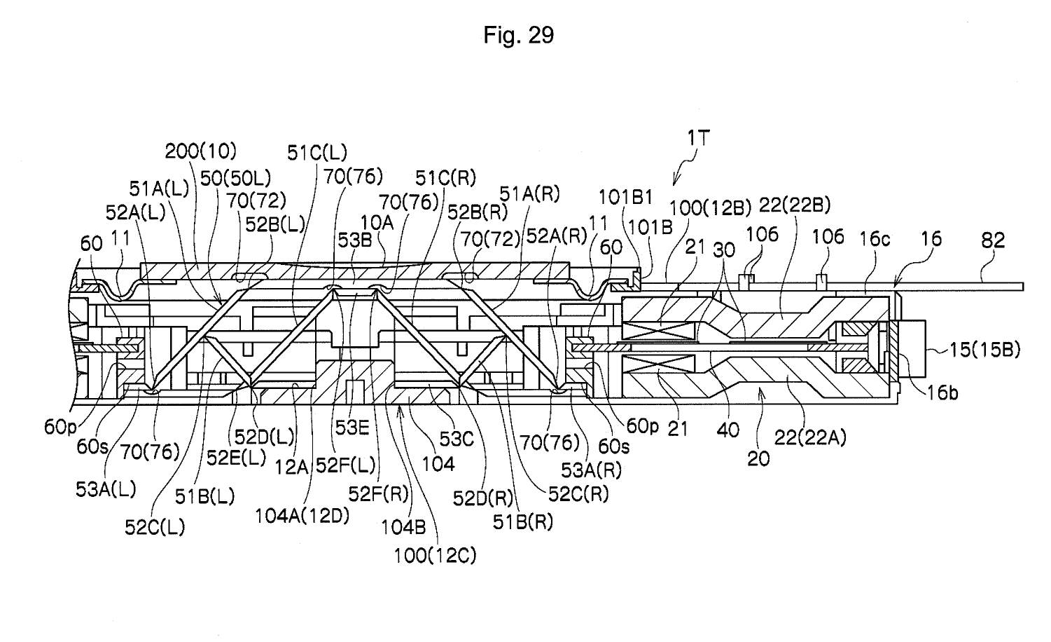

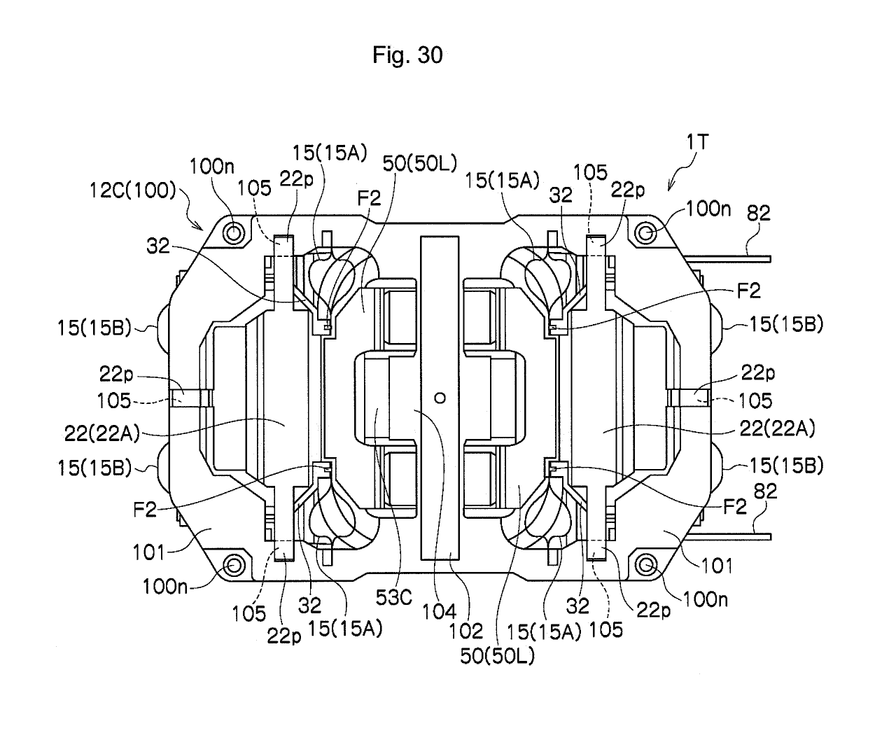

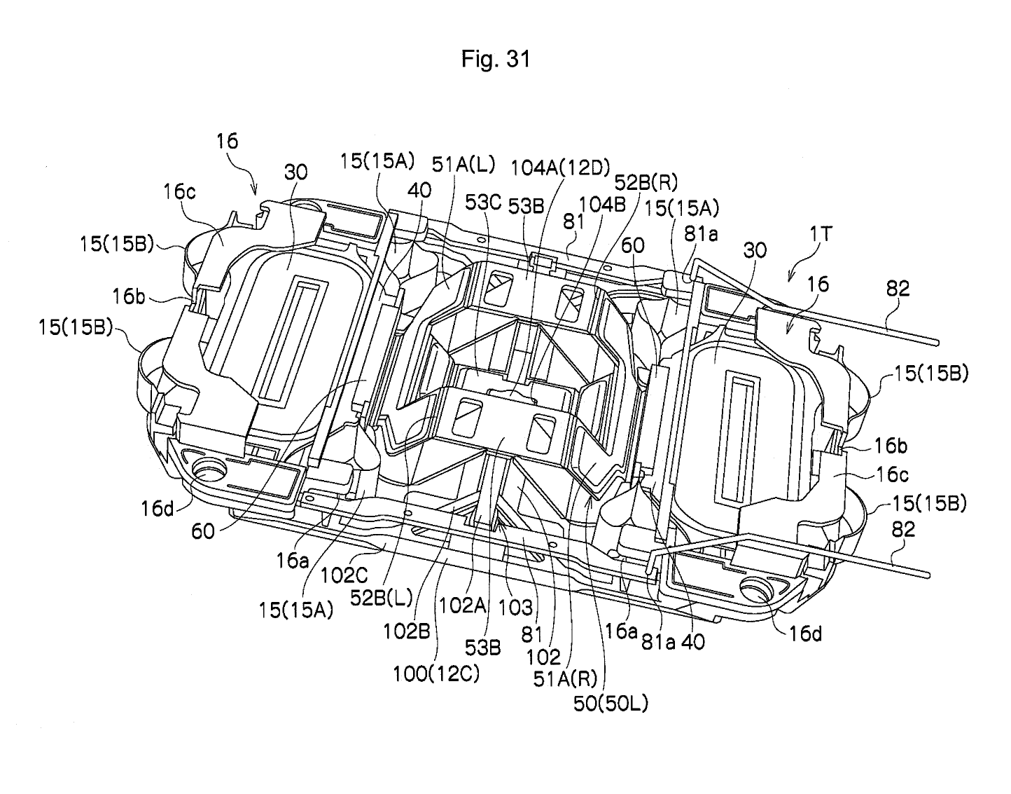

FIGS. 28 to 31 are views illustrating the speaker device 1T according to an embodiment of the present invention (FIG. 28 is a plan view, FIG. 29 is a cross-sectional view taken along line X-X, FIG. 30 is a rear view and FIG. 31 is a perspective view without a first frame). The same symbols are applied to the same parts and duplicated explanations are eliminated. The example shown in FIGS. 11 and 12 are adopted as the vibration direction converter part 50.

According to the example shown in FIG. 28, the diaphragm 10 is formed in a rectangular shape viewed from the sound emission direction, and a curved portion 10A with ellipticalouter shape and concave cross-sectional shape is formed near the central part, and thus the diaphragm 10 has a predetermined bending rigidity in the vibration direction of the diaphragm 10 and the vibration direction of the voice coil 30. Further, with the concave shaped curved portion 10A formed at the diaphragm 10, density of the curved portion 10A becomes larger than other part of the diaphragm 10 and thereby rigidity may be made comparatively large. Further, when a pair of the vibration direction converter parts 50 are arranged opposite each other, the curved portion 10A is formed between a pair of the hinge parts 52B which are formed between the vibration direction converter part 50 and the diaphragm 10.

Since the diaphragm 10 has rigidity (bending rigidity included) in the vibration direction of the diaphragm, generation of deflection, etc. of the diaphragm 10 may be restrained, and thus generation of difference in phase between sound waves, deterioration of acoustic characteristic, etc. may be restrained. Further, with the curved portion 10A of the diaphragm 10 formed between a pair of the hinges 52B that is formed between the vibration direction converter part 50 and the diaphragm 10, generation of deflection may be restrained.

Further, the diaphragm 10 is formed substantially in a rectangular shape including a short axis extending in the vibration direction of the voice coil 30 and a long axis extending along the direction orthogonal to the vibration direction of the voice coil 30, a reinforcing part (not shown) may be formed in the direction of the long axis or the short axis. The reinforcing part includes a groove part, having, for example, V-shaped cross-section, which is formed linearly, annularly or in a lattice shape in the front face or rear face of the diaphragm 10. For example, filling material such as damping material may be applied to inside of the groove part. As such, with the groove part filled by the filling material, rigidity (bending rigidity included) of the diaphragm 10 may be increased and the peak and dip of sound pressure frequency characteristic of a speaker may be lowered. Further, as another example of the reinforcing part, for example, fiber member made of unwoven fabrics (not shown), etc. may be applied instead of forming the groove part. With the reinforcing part constructed with the fiber member as described above, rigidity (bending rigidity) of the diaphragm 10 may be increased, and thus generation of deformation such as deflection in the diaphragm 10 due to vibration or air resistance transmitted from the vibration direction converter part when the diaphragm 10 vibrates, may be restrained. Further, provided with the reinforcing part, an internal loss of the diaphragm 10 may be improved.

Further, the diaphragm 10 is formed with a first layer constructed with foamed resin including acrylic resin, etc. and a second layer including a fiber member such as a glass fiber, configuring a stacking structure in which the first layer is sandwiched between a pair of the second layers. As a forming material of the diaphragm 10, for example, resin material, metal material, paper material, fiber material, ceramics material, compound material, etc. may be adopted.

The edge 11, vibratably supporting the diaphragm 10 at the frame 12 as the static part 100, is arranged between the diaphragm 10 and the frame 12, and the inner periphery part supports the outer periphery part of the diaphragm 10 while the outer periphery part is connected to the frame 12 directly or via other member, and thus the diaphragm 10 is held at a prescribed position. As other member, elastic member functioning as a packing (including resin member), adhesive resin, etc. are included. More specifically, the edge 11 vibratably supports the diaphragm 10 in the vibration direction (Z-axis direction), and restrains vibration in the direction orthogonal to the vibration direction (Y-axis direction). The edge 11 is formed in a ring shape (annular shape) viewed from the sound emission direction, and the cross-section of the edge 11 is formed in a prescribed shape, for example, a concave shape, convex shape, corrugated shape, etc. in the sound emission direction. As the forming material of the edge 11, conventional material, for example, fur, cloth, rubber, resin, a filler-applied member with a material such as fur, cloth, rubber or resin, rubber member or resin member molded in a prescribed shape, may be adopted. Further, in a part or whole circumference of the edge 11, a projection part projecting from the front face (in the sound emission direction), or from the rear face (in the direction opposite to the sound emission direction) or a concave portion may be formed, rigidity of the edge 11 in a prescribed direction may be increased.

The static part 100 is divided into a first frame 12B (a first configuring member 100A) and a second frame 12C (a second configuring member 100B), and the diaphragm 10 is supported around an opening part at the center of the first frame 12B via the edge 11. The magnetic circuit 20 has a structure, which can be divided into two parts sandwiching the voice coil 30, one part arranged above and the other part arranged below the voice coil 30. The upper one part is supported by the first frame 12B and the lower other part is supported by the second frame 12C. According to the example shown in the drawing, an upper yoke 22B with respect to the first frame 12B and a lower yoke 22A with respect to the second frame 12C are supported substantially in parallel respectively.

The static part 100 includes an outer peripheral frame part 101 surrounding the diaphragm 10 and a bridge part 102 bridging inside of the outer peripheral frame part 101. The bridge part 102 exerts a reaction force on the above link body 50L (vibration direction converter part 50), and has rigidity in the vibration direction of the link body 50L.

As described above, upon vibration of the voice coil 30, the vibration is transmitted to the diaphragm 10 via the link body 50L. At this time, the link body 50L angle converting the link part 51 is subjected to a reaction force exerted by the diaphragm 10. When the link body 50L is subjected to this reaction force, if the static part 100 supporting the link body 50L is deflected, the link body 50L itself vibrates, and thus the link body 50L may transmit unwanted vibration to the link part 51. When the unwanted vibration transmitted to the link part 51 is transmitted to the diaphragm 10, the vibration of the voice coil 30 may not be efficiently transmitted to the diaphragm 10. Accordingly, the bridge part 102, which is a part of the static part 100 supporting the link body 50L, is provided with a function of restraining generation of deflection, and thus unwanted vibration that may be transmitted to the link part and the diaphragm 10 may be restrained. As such, vibration of the voice coil 30 may be efficiently transmitted to the diaphragm 10.

In order that the bridge part 102 supporting the link body 50L may have rigidity against a force exerted by the diaphragm 10 via the link body 50L, compliance of the bridge part 102 is preferably substantially the same or smaller than compliance of the outer peripheral frame part 101 in the vibration direction of the diaphragm 10. More specifically, thickness of the bridge part 102 is preferably substantially the same or larger than thickness in a part of the static part 100 supporting the diaphragm 10 or the magnetic circuit 20.

In the example shown in the drawing, the bridge part 102 provided at the second frame 12C has a first projection part 102A projecting in the direction that the bridge part entends and in the vibration direction of the diaphragm 10. This first projection part 102A includes a rib structure formed in a longitudinal direction of the bridge part 102, which increases bending rigidity of the bridge part 102. Further, a second projection part 102B is formed extending in the direction crossing the first projection part 102A, in the plane of the bridge part 102 facing the diaphragm 10. This second projection part 102B acts as a reinforcing rib at both end portions of the bridge part 102, and rigiditly supports the bridge part 102 at the outer peripheral frame part 101 by both end portions.

Further, the bridge part 102 has a third projecting part 102C crossing the first projection part 102A and the second projecting part 102B. The third projecting part 102C is formed in the plane of the static part 100 facing the diaphragm 10, and a reinforcing part 103 having polygonal planar shape is formed with a plurality of the second projection part 102B and the third projecting part 102C.

Further, the first frame 12B includes the outer peripheral frame part 101 of the static part 100 as a first outer peripheral frame part 101A, and includes a second outer peripheral frame part 101B supporting the diaphragm 10 inside the first outer peripheral frame part 101A. An opening inside the second outer peripheral frame part 101B is sealed by the edge 11 and the diaphragm 10. A projection part 101B1 projecting in the sound emission direction is formed at the second outer peripheral frame part 101B by which the diaphragm 10 is supported via the edge 11. With this projection part 101B1, rigidity to support the circumpherence of the diaphragm 10 is obtained.

The first frame 12B and the second frame 12C configuring the static part 100 are formed in a planar shape having a long axis and a short axis, and the bridge part 102 is formed in the short axis direction. Further, the bridge part 102 may be formed in the long axis direction or in the long and short axis directions, and thus rigidity of the static part 100 may be obtained.

Convex portions 100m are formed at the four corners of the first frame 12B, and concave portions 100n are formed at the four corners of the second frame 12C. The convex portions 100m and the concave portions 100n are fitted such that the first frame 12B and the second frame 12C are coupled. The convex portion 100m may be formed at one of the first frame 12B and the second frame 12C, and the concave portion 100n may be formed at the other one of the first frame 12B and the second frame 12C. The concave portion 100n may be formed to be a hole.

The vibration direction converter part 50 includes a first link part 51A and a second link part 51B as the link body 50L, and one end of the second link part 51B is supported by the first link part 51A and the other end is supported by the bridge part 102. The bridge part 102 supporting the second link part 51B is formed in a tabular shape, and a connecting part 104, where the other end of the second link part 51B and the bridge part 102 are connected, forms a single plane.

With the other end of the second link part 51B fitted in the bridge part 102, the vibration direction converter part 50 and the bridge part 102 are connected. A projection part 104A is formed at the connecting part 104 of the bridge part 102, and a hole 104B in which the projection part 104A is inserted, is formed at the connecting part 53C integrally formed at the end of the second link part 51B via the hinge part 52.

The projection part 104A of the connecting part 104 in the bridge part 102 acts as a positioning part positioning the vibration direction converter part 50 with respect to the static part 100. The vibration direction converter part 50 is positioned with respect to the static part 100, with the projection part 104A inserted into the hole 104B at the connecting part 53C, which is integrally formed at the end of the second link part 51B via the hinge part 52.

In the condition that the first frame 12B and the second frame 12C as a static part 100 are connected, the second connecting part 53B of the vibration direction converter part 50 is connected to the rear side of the diaphragm 10 supported by the first frame 12B, and the static connecting part 53C of the vibration direction converter part 50 is connected to the connecting part 104 formed at the central part of the bridge part 102 in the second frame 12C.

The second connecting part 53B is a part integrally formed at the end of the first link part 51A via the hinge part 52B, and the end of the first link part 51A and the diaphragm 10 is connected with this second connecting part 53B connected to the diaphragm 10. A concave portion is formed at the face of the diaphragm 10 in the sound emission side facing the second connecting part 53B, and the diaphragm 10 has rigidity. The static connecting part 53C is a part integrally formed at the end of the second link part 51B via a hinge part 52D, and the hole 104B is formed at the connecting part 53C. The projection part 104 is inserted into the hole 104B, and thereby the connecting part 104 and the end portion of the second link part 51B are connected.

The voice coil support part 40 supporting the voice coil 30 has one end portion at which the connecting part 60 is attached in the vibration direction of the voice coil supporting part 40, and the connecting part 60 is attached such that the connecting part 60 extends along the width of the voice coil support part 40. The connecting part 60 includes a connecting step part 60s to which the first connecting part 53A of the vibration direction converter part 50 is detachably connected, and a through hole 60p passing through in the vibration direction of the voice coil support part 40. The through-hole 60p is a vent hole formed to reduce air resistance exerted to the connecting part 60 upon vibration of the voice coil support part 40.

This connecting part 60 connects the first connecting part 53A of the vibration direction converter part 50 and the end portion of the voice coil support part 40 with an interval, which allows the height of the magnetic circuit 20 to fall within the range of the height of the vibration direction converter part 50.

This voice coil support part 40 and the connecting part 60 are held by the holding part 15 at the first frame 12B and the second frame 12C. The holding part 15 includes the first holding part 15A and the second holding part 15B, having curved plate member which allow a deformation in one direction in the vibration direction of the voice coil support part 40 and restrict deformations in other directions. The first holding part 15A and the second holding part 15B hold the voice coil support part 40 at the first frame 12B and the second frame 12C via the attachment unit 16. The first holding part 15A holds the connecting part 60 at one side part of the attachment unit 16, and the inner end portions of the first holding part 15A in the right side and left side are connected to both outer end portions of the connecting part 60, and each of outer ends of the first holding part 15A is connected to the attachment unit 16. Further, the first holding part 15A is formed with a conducting metal and electrically connected to a lead wire 31 extending from the end portion of the voice coil 30 via the voice coil lead wire 32 (conducting layer 43), and an audio signal is supplied to the voice coil 30 via the first holding part 15A. Further, the first holding part 15A is electrically connected to linear terminal parts 81, 81 supported by the frame 12, and is electrically connected to outside via wirings 82, 82 electrically connected to these terminal parts 81, 81.

The second holding part 15B has the central part connected to other side part of the attachment unit 16 and both end portions connected to the right and left end portions of the voice coil support part 40. In this example, the second holding part 15B is arranged within the width of the voice coil support part 40 such that a holding body of the voice coil support part 40 does not take up space in the width direction of the voice coil support part 40. Further, although the second holding part 15B, which is formed with a continuous member, has a continuous shape at the central part, it may be formed by a plurality of members. Although a part of the second holding part 15B is arranged projecting outside the static part 100, a part of the second holding part 15B may be modified so as to fit into the static part 100.

A pair of common terminal parts 81, 81 with respect to a plurality of the voice coils 30, 30, extending from one voice coil 30 to another voice coil 30 among a plurality of voice coils, is provided at the static part 100 in order to input an audio signal to the voice coils 30, corresponding to a plurality of the driving parts 14. Further, the terminal parts 81, 81 are arranged in an opening (not shown) formed between the first frame 12B and the second frame 12C, which configure the frame 12 as the static part 100. As such, space may be saved in arrangement of the terminal part compared to the case in which an individual terminal part is arranged at both end portions of each voice coil 30, and thus a speaker device may be made small or thin. Further, the terminal parts 81, 81 may be stably fixed to the static part 100, and thereby a bad connection to the voice coils 30, 30 may be avoided. Further, the terminal parts 81, 81 are formed to have a long axis extending from one voice coil 30 to another voice coil 30 and a short axis crossing the long axis. With the long and thin shape as above, efficiency of the installation space may be improved.

The terminal parts 81, 81 include connecting parts 81a connected to wirings 82, 82 (second wiring), which are electrically connected to outside and the terminal parts 81, 81 are electrically connected at the connecting part 81a. The wirings 82 are fixed to the side face of the static part 100 and connected to the terminal parts 81, 81. The outer peripheral frame part 101 of the static part 100 includes a side face to which a wiring 82 is attached, and guiding parts 106, 106 guiding the wire 82 are formed at the side face of the static part 100.

Further, the voice coil lead wire 32 (conducting layer 43), connected to the lead wire 31 extending from the end portion of the voice coil 30, is formed on the voice coil support part 40 (base) supporting the voice coil 30. The conducting layer 43 is pattern-formed on the voice coil support part 40 (base) surrounding the conducting member of the voice coil 30, and this conducting layer 43 electrically connects the conducting member of the voice coil 30 and the holding part 15.

A wiring, electrically connecting the voice coil 30 and the terminal parts 81, is formed at the holding part 15 and the end portions of the terminal parts 81, 81 and the wiring are electrically connected. The wiring of the holding part 15 and the voice coil lead wire are connected, and the terminal parts 81, 81 and the wire 82 are connected, and thereby an external audio signal is inputted to the voice coil 30.

A connecting part F1, connected to the terminal parts 81, 81, is formed at the holding part 15. This connecting part F1 extends in the direction crossing the vibration direction of the diaphragm 10 (X-axis direction), and is formed in a tabular shape so as to contact with the terminal parts 81, 81. Also, a connecting part F2, connected to the voice coil lead wire 32, is formed at the holding part 15. The connecting part F2 extends in the direction crossing the vibration direction (Z-axis direction) of the diaphragm 10 and is formed in a tabular shape so as to contact with the end portion of the voice coil lead wire 32.

In the attachment unit 16, the attachment unit 16 includes an integral support part 16c integrally supporting a first connecting part 16a and a second connecting part 16b, the first connecting parts 16a, to which the end portion of the first holding part 15A is connected, are provided at both right and left sides of the connecting part 60, and the second connecting part 16b, to which the second holding part 15B is connected, is formed at the back of the voice coil support part 40. Further, connecting holes 16d, opposite to the convex portions 100m provided at the first frame 12B of the static part 100, are provided at the four corners of the attachment unit 16. With the convex portion 100m inserted into the connecting hole 16d and the concave portion 100n provided at the second frame 12C, the voice coil support part 40, the connecting part 60, the holding part 15 and the attachment unit 16 are unitized and fixed between the first frame 12B and the second frame 12C.

Further, when assembling the speaker device 1T, the first connecting parts 53A (R), 53A(L) of the direction converter part 50 shown in FIGS. 11 and 12 are attached to the connecting step part 60s of the connecting part 60 such that the vibration direction converter part 50 and those already unitized, including the voice coil support part 40, the connecting part 60, the holding part 15 (the first holding part 15A and the second holding part 15B) and the attachment unit 16, are integrated. The upper yoke part 22B and the lower yoke part 22A of the magnetic circuit 20 are arranged above and below these parts (voice coil support part 40 included) respectively and sandwiched by the first frame 12B and the second frame 12C of the static part 100. As such, the static connecting part 53C of the vibration direction converter part 50 is fitted in and immovably supported by a support table 12D formed at the bottom portion 12A of the second frame 12C and other parts such as the attachment unit 16 are also positioned at predetermined locations with respect to the first frame 12B and the second frame 12C. Further with the convex portions 100m provided at the first frame 12B of the static part 100 inserted into the connecting holes 16d provided at the four corners of the attachment unit 16, the attachment unit 16 may be fixed at a predetermined position with respect to the static part 100.

In the example shown in the drawing, the upper yoke 22B of the magnetic circuit 20 is first mounted to the inner face of the first frame 12B, and then the attachment unit 16, the vibration direction converter part 50, etc. are mounted thereto, and thus positioned respectively. And, the second frame 12C is stacked so as to sandwich each component between the first frame 12B and the second frame 12C while the lower yoke 22A of the magnetic circuit 20 is mounted thereto. Finally, the second connecting part 53B of the vibration direction converter part 50 and the diaphragm 10 are joined with adhesive as a joining member, while the outer periphery part of the diaphragm 10 is attached to the second outer peripheral frame part 101B of the first frame 12B via the edge 11. Further, a groove part is circumferenctially formed at the bottom portion of the second outer peripheral frame part 101B near the outer periphery part of the edge 11. The groove part is formed as a joining member reception part receiving protrusion of adhesive as a joining member joining the edge 11 and the first frame 12B. Further, a projection part projecting toward the frame 12B at the outer periphery of the edge 11 is formed and inserted into the groove, and thus a joining strength of the edge 11 and the first frame 12B may be strengthened.

Further, the assembling processes may be constructed as follows:

First, the wirings 82 is connected to the connect terminals 81, 81, and the magnet 21 is connected to the yoke 22. Next, the connect terminals 81, 81, to which the wirings 82 is connected, is attached to the outer peripheral frame part 101A of the first frame 12B. Next, a pair of the attachment units 16, to which the above voice coil 30 is attached, is attached to the first frame 12B. The connect terminals 81, 81 and the holding part 15A attached to the attachment unit 16 are electrically connected by soldering, etc. Next, the vibration direction converter part 50 is attached to the connecting part 104, and thus the vibration direction converter part 50 and the voice coil 30 are connected. Next, the second frame 12C is arranged on the first frame 12B, and the magnetic pole member (yoke part) 22 joined to the magnet 21 is attached to the outer peripheral frame part 101A of the second frame 12C. Next, the diaphragm 10 and the edge 11 are connected to the second outer peripheral frame part 101B of the first frame 12B. Next, the magnetic pole member (yoke part) 22 joined to the magnet 21 is attached to the outer peripheral frame part 101A of the first frame 12B. Finally, the wiring 82 is attached to the guiding part 106 provided at the first outer peripheral frame part 101A of the first frame 12B.

The frame 12 as the static part 100 includes the first frame 12B (the first configuring member) and the second frame 12C (the second configuring member) as described above, and the first frame 12B is arranged in the sound emission side of the speaker device 1T, while the second frame 12C is arranged in the opposite side (rear side) of the sound emission side. The driving part 14 of the speaker device 1 is supported so as to be sandwiched between the first frame 12B and the second frame 12C.

The annularly formed outer peripheral frame part 101 of the first frame 12B supports one side (22B) of the magnetic pole members (yoke part) 22

Meanwhile, the second frame 12C includes the outer peripheral frame part 101 and the bridge part 102 and supports the other side (22A) of the magnetic pole member (yoke part) 22 of the magnetic circuit 20.

The first frame 12B and the second frame 12C include a concave receiving part 105 receiving a part of the yoke part 22. A projecting part 22p is fitted into this receiving part 105 and the yoke part 22 is positioned to form a proper magnetic gap. Further, an opening 101s is formed between the bridge part 102 and the outer peripheral frame part 101 of the second frame 12C. The fourth projecting part (not shown) is formed along the outer periphery of the opening 101s of the outer peripheral frame part 101. The fourth projection part increases torsional rigidity of the outer peripheral frame part 101.

Further, an excessive-vibration restraining part 108 is formed at the first frame 12B to restrain an excessive vibration of the voice coil 30. The excessive-vibration restraining part 108 projects into a movable region of the voice coil 30, and an excessive vibration of the voice coil 30 is restrained with the excessive-vibration restraining part 108 contacted with the voice coil support part 40. More specifically, a notch part 41f is formed at the base of the voice coil support part 40, and the projection part of the excessive-vibration restraining part 108 is arranged in the notch part 41f (see FIG. 22).

The magnetic circuit 20 is attached to the first frame 12B and the second frame 12C with the magnetic pole member 22 joined to the magnet. The magnetic pole member 22 has a plurality of projection parts 22p and the projection parts 22p are supported by the receiving part 105. A width of the plate shaped yoke part 22 is decreased from the vibration direction converter part 50 to the static part 100, and thus the holding part 15 is prevented from contacting the yoke part 22.

The magnetic circuit 20 has the yokes 22A and 22B attached to the first frame 12B and the second frame 12C, and an interval as the magnetic gap 20G is provided between the yokes 22A and 22B or the magnetic 21 by connecting the first frame 12B and the second frame 12C.

According to this embodiment, the height of the magnetic circuit 20 is substantially the total height of the whole device, and the voice coil support part 40 is configured to vibrate near the center of the magnetic circuit 20, while the end portion of the voice coil support part 40 and the end portion of the vibration direction converter part 50 are connected at different heights via the connecting part 60. As such, each link part of the vibration direction converter part 50 can secure a sufficient length within the height of the device, and a part of the height of the magnetic circuit 20 can be failed within the height of the vibration direction converter part 50. Further, with an interval formed between the first frame 12B and the upper yoke part 22B arranged near the first frame 12B, contact between the magnetic circuit 20 and the voice coil 30, caused by the vibration of the diaphragm 10 being transmitted to the magnetic circuit 20 via the upper yoke part 22B, may be restrained.

Accordingly, the speaker device according to embodiments or examples of the present invention can be made thin and can make louder sound. Further, a thin speaker device capable of emitting louder reproduced sound with a comparatively simple structure can be realized by vibrating the diaphragm in a direction different from the vibration direction of the voice coil. When converting the vibration direction of the voice coil to a different direction by using a mechanical link body, durability of the hinge part of the link body that can tolerate the high-speed vibration specific to a speaker device and flexibility that can restrain generation of abnormal sound during high-speed vibration, may be required. According to the configuration of the speaker device described above, the hinge part of the link body can have the durability and flexibility.

Further, in order to direction convert the vibration of the voice coil and transmit the vibration of the voice coil to the diaphragm, it is necessary to efficiently and accurately reproduce the vibration of the voice coil, and thus it may be necessary to prevent the link body from being deformed and make the link body itself light. In addition, it may be necessary to easily incorporate the link body into the speaker device and easily manufacture the link body itself. According to the configuration of the speaker device described above, a speaker device, which is light weight and easy to manufacture, can be realized.

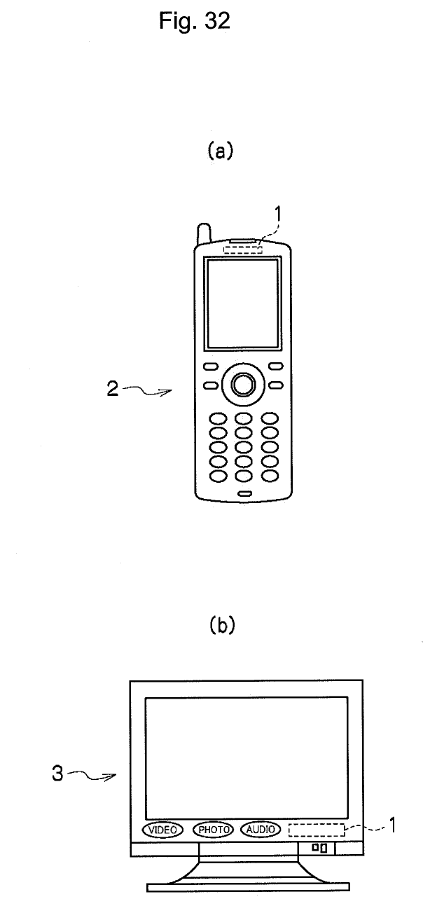

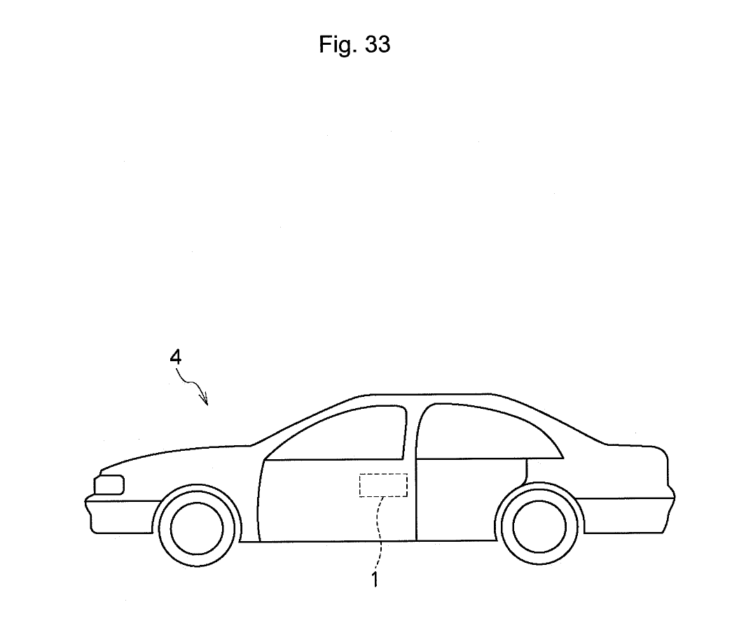

This speaker device can be efficiently used as various types of electronic devices or in-car devices. FIG. 32 is a view illustrating an electronic device including a speaker device according to an embodiment of the present invention. In an electronic device 2 such as a mobile phone or a handheld terminal shown in FIG. 32(a) or an electronic device 3 such as a flat panel display shown in FIG. 32(b), a speaker device is housed in the housing, which act as the attaching counterpart provided at the electronic device 3. And the speaker device is attached to the side face of the housing as the attaching counterpart of the electronic device. Even if this case, since installation space in thickness direction required for installing the speaker device 1 may be decreased, the whole electronic device may be made thin. Further, a sufficient audio output may be produced even by the electronic device made thin. FIG. 33 is a view illustrating an automobile provided with a speaker according to an embodiment of the present invention. In an automobile 4 shown in FIG. 33, in-car space may be widened with the speaker device 1 made thin. More particularly, the speaker device 1 according to the embodiment of the present invention, even if attached to a door panel, ceiling, rear tray or a dashboard as the attaching counterpart, may comparatively reduce a bulge projecting into a door panel, ceiling, and thus enabling to widen space for a driver to operate or space inside room. Further, with sufficiently produced audio output, it is possible to enjoy listening to music or radio broadcasting pleasantly in a car even when driving on a noisy highway.

Further in a resident building, a hotel, an inn or a training facility as a building including a speaker device, when the speaker device 1 is provided on a wall or ceiling as the attaching counterpart, installation space in thickness direction required for the speaker device 1 may be reduced and thus enabling to save space in a room and make effective use of space. The hotel is capable of holding an event and accommodating many guests for conference, meeting, lecture, party, etc. Further, providing a room equipped with audiovisual equipment can be seen in recent years along with prevalence of a projector or a big-screen TV. On the other hand, there is also seen a living room, etc. used as a theater room without room equipped with audiovisual equipment. Also in this case, the living room, etc. can be easily converted to a theater room with the speaker device 1 while making effective use of space in the living room. More particularly, the placement at which the speaker device 1 is arranged may be, for example, ceiling or wall, etc. (attaching counterpart).

Although the embodiments according to the present invention are described with reference to the drawings, specific configurations are not limited to these embodiments, and modifications not departing from the subject matter of the present invention are included in the scope of the present invention. Further, the technology of each embodiment described above can be used by each other, unless specific contradictions or problems are found in their objects, the configurations, etc. In addition, PCT/JP2008/051197 filed on Jan. 28, 2008, PCT/JP2008/068580 filed on Oct. 14, 2008, PCT/JP2008/069480 filed on Oct. 27, 2008, PCT/JP2008/069269 filed on Oct. 23, 2008, PCT/JP2009/053752 filed on Feb. 27, 2009, PCT/JP2009/053592 filed on Feb. 26, 2009, PCT/JP2009/050764 filed on Jan. 20, 2009, PCT/JP2009/055533 filed on Mar. 19, 2009, PCT/JP2009/055496 filed on Mar. 19, 2009, PCT/JP2009/055497 filed on Mar. 19, 2009, PCT/JP2009/055498 filed on Mar. 19, 2009, PCT/JP2009/055534 filed on Mar. 19, 2009, PCT/JP2009/055523 filed on Mar. 19, 2009, PCT/JP2009/055524 filed on Mar. 19, 2009, PCT/JP2009/055525 filed on Mar. 19, 2009, PCT/JP2009/055526 filed on Mar. 19, 2009, PCT/JP2009/055527 filed on Mar. 19, 2009, PCT/JP2009/055528 filed on Mar. 19, 2009 are incorporated by reference into the present application.

1. A speaker device comprising:
a diaphragm,
a static part vibratably supporting said diaphragm, and
a driving part provided at said static part and vibrating said diaphragm upon an audio signal, wherein said driving part includes:
a voice coil vibrating in a direction different from said diaphragm upon the audio signal inputted,
a magnetic circuit including a magnetic gap in which said voice coil is arranged,
a rigid vibration direction converter part obliquely disposed with respect to the vibration direction of said voice coil and said diaphragm and connected with said voice coil and said diaphragm, and
a holding part holding said voice coil at said static part, wherein said holding part restricts the vibration of said voice coil in one axis direction.

2. The speaker device according to claim 1, wherein said holding part includes a plate-shaped curved portion.

3. The speaker device according to claim 2, wherein said curved portion has a concavo-convex cross-sectional shape in the vibration direction of said voice coil and has a constant shape in the vibration direction of said diaphragm.

4. The speaker device according to claim 2, wherein said curved portion has a side face linearly extending in the vibration direction of said diaphragm.

5. The speaker device according to claim 2, wherein said curved portion has smaller bending rigidity in the vibration direction of said voice coil than that in the vibration direction of said diaphragm.

6-9. (canceled)

10. The speaker device according to claim 5, wherein said holding part is formed with a plurality of configuring members.

11. The speaker device according to claim 10, wherein
said plurality of configuring members are arranged opposite each other, and
a space is formed between said configuring members, surrounded by said configuring members.

12. (canceled)

13. The speaker device according to claim 11, wherein said holding part has a substantially line-symmetrical shape.

14. The speaker device according to claim 13, wherein
said holding part includes a tabular portion with linear cross-sectional shape at least at an end of said holding part, and
said tabular portion is continuously formed from said curved portion.

15. The speaker device according to claim 14, comprising a connecting part connecting said voice coil and said vibration direction converter part, wherein
said connecting part, forming an interval in the vibration direction of said diaphragm between the end on the side of said voice coil of said vibration direction converter part and the end on the side of said vibration direction converter part of said voice coil, connects both ends, and
said tabular portion is connected to said connecting part.

16. (canceled)

17. The speaker device according to claim 15, wherein
said voice coil includes end edges at one end and the other end in the vibration direction of said voice coil extending in a direction crossing said vibration direction, and
said end edges are supported by said static part at said holding part.

18. The speaker device according to claim 17, comprising an attachment unit arranging said voice coil at a prescribed position with respect to said static part, wherein
said holding part has one end connected to the end edge of said voice coil and the other end of said voice coil connected to said attachment unit.

19-21. (canceled)

22. The speaker device according to claim 18, wherein
said holding part holds at said static part the end edge of said voice coil in the opposite side of said vibration direction converter part,
said holding part forms an integrated component including a pair of said curved portions, arranged in the direction that the end edge of said voice coil extends, and
said integrated component is provided with a reinforcing member.

23. The speaker device according to claim 22, wherein said reinforcing member causes an internal loss to said integrated component.

24-25. (canceled)

26. The speaker device according to claim 1, wherein said holding part is deformable in the vibration direction of said voice coil and has rigidity in the vibration direction of said diaphragm.

27. (canceled)

28. The speaker device according to claim 10, wherein one of said configuring members is formed with a rigid material and another one of said configuring members is formed with a material causing an internal loss.

29-30. (canceled)

31. The speaker device according to claim 1, wherein said holding part is a damper formed with a rigid member holding said voice coil at a prescribed height with respect to said static part.

32-36. (canceled)

37. The speaker device according to claim 1, wherein
said vibration direction converter part has one end angle-variably connected to said voice coil and the other end angle-variably connected to said diaphragm, and
said vibration direction converter part includes a rigid link part obliquely disposed with respect to the vibration direction of said diaphragm and the vibration direction of said voice coil.

38. The speaker device according to claim 1, wherein said vibration direction converter part includes a link body angle-converting a link part formed between said voice coil support part and said diaphragm.

39. The speaker device according to claim 1, comprising a connecting part arranged between the end on the side of said voice coil of said vibration direction converter part and the end on the side of said vibration direction converter part of said voice coil, wherein
said vibration direction converter part connects said ends of said voice coil and said vibration direction converter in different positions in said vibration direction.

40. The speaker device according to claim 1, wherein
said vibration direction converter part is connected to an attaching counterpart including said diaphragm and said voice coil and includes a hinge part in the proximity of said attaching counterpart, and
a contact avoiding part avoiding contact with said hinge part is formed on the face side of said attaching counterpart in the proximity of said hinge part.

41. The speaker device according to claim 1, wherein
said vibration direction converter part is connected to an attaching counterpart including said diaphragm and said voice coil and includes a hinge part in the proximity of said attaching counterpart, and
a reception portion of adhesive material joining said vibration direction converter part and said attaching counterpart is formed on the face side of said attaching counterpart facing said hinge part.

42. The speaker device according to claim 1, wherein
said vibration direction converter part includes a rigid link part angle-variably obliquely disposed between said voice coil and said diaphragm, and hinge parts formed at both ends of said link part, and
said each of the hinge parts is formed with a bendable continuous member continuing between parts of said hinge part on both sides over said hinge part.

43. (canceled)

44. The speaker device according to claim 1, wherein said voice coil includes a planarly and annularly wound conducting member and a rigid base supporting said conducting member, and a conducting layer is pattern-formed in a surface of said base outside the said conducting member.

45. The speaker device according to claim 44, comprising a pair of said conducting layers arranged so as to surround said conducting member, wherein said conducting layer acts as a junction wire inputting an audio signal to said conducting member.

46. An electronic device comprising the speaker device according to claim 1.

47. An automobile comprising the speaker device according to claim 1.

48. A building comprising the speaker device according to claim 1.

49. A speaker device comprising:
a diaphragm,
a static part vibratably supporting said diaphragm, and
a driving part provided at said static part and vibrating said diaphragm upon an audio signal, wherein said driving part includes:
a tabular-shaped voice coil vibrating in a direction different from said diaphragm upon the audio signal inputted,
a magnetic circuit including a magnetic gap in which said voice coil is arranged,
a rigid vibration direction converter part connected with said voice coil and said diaphragm, and
a holding part holding said voice coil at said static part, wherein said holding part restricts the vibration of said voice coil in one axis direction.
